(19) United States
(12) Patent Application Publication
(10) Pub. No.: US 2014/0334206 A1
(43) Pub. Date: Nov. 13, 2014

(54) METHOD FOR BALANCING CAPACITORS IN AN INVERTER

(71) Applicant: Massimo Valiani, Corciano (IT)

(72) Inventor: Massimo Valiani, Corciano (IT)

(73) Assignee: Power-One Italy S.p.A., Terranuova Bracciolini (IT)

(21) Appl. No.: 14/236,505

(22) PCT Filed: Aug. 2, 2011
(86) PCT No.: PCT/IT2011/000283

§ 371 Date: Aug. 1, 2014

(51) Int. Cl. H02M 7/537

(52) U.S. Cl. CPC H02M 7/537
USPC 363/97

(57) ABSTRACT

The PWM modulating method comprises the following steps: detecting actual voltage values (Vc1, Vc1, Vc2, Vc3 . . . ) across bulk capacitors (C1, C2, C3) provided across input terminals of said inverter; calculating a duty cycle vector (D) based on electric parameters defining a rotating vector (V0) representing an output electric quantity required from the inverter; and modifying said duty cycle vector (D) as a function of said actual voltage values to re-balance said bulk capacitors.

### TECHNICAL FIELD

The present invention relates to inverters, in particular single or multi-level multi-phase inverters. More specifically, the invention relates to a capacitor balancing system that exploits the space vector modulation principle.

### BACKGROUND ART

Modulation is the technique that makes operation of electric machines based on the PWM (Pulse Width Modulation) possible. A variety of electric machines use the PWM to produce an output voltage whose profile variation overtime has the desired shape (for example, but not necessarily, sinusoidal) and it is used to supply power to other machines, for example electric motors or to transfer electrical energy on a distribution grid. In general, an electric machine needs to receive an input voltage with variable modulus and frequency; in the case of an electric motor, for example, this variable input source is used to vary the rotation speed of the motor as a function of specific load conditions. Modulation consists of a continuous comparison in the time domain between a high frequency carrier and a low frequency modulating waveform. The signal obtained from this comparison is used to drive the high frequency opening and closing of the electronic switches of the inverter.

Modulation techniques can be of various kinds. The present invention relates to improvements to a Space Vector Modulation technique, whose basic principles will be summarized below, before describing in detail some embodiments of the improved method of the invention.

The number of controlled electronic switches of an electric machine rises both with the number of output phases and with the number of voltage levels. The higher the number of switches, the greater the complexity of the driving system, with consequent increased complexity of the digital or analog modulator subsystem. This computational requirements limits the number of switches that can be used in an inverter machine of this type or, conversely, it forces the use of particularly expensive logic circuits to support the implementation of multilevel inverters. However, a higher number of voltage levels gives the benefit of the reduction in the harmonic content of the output voltage produced by the inverter, with an advantage in terms of operation and quality of the resulting electric current.

Examples of Space Vector Modulation PWM applied to various types of multi-phase and multi-level inverters, are reported in H. Djeghloud et al, “Space Vector Pulse Width Modulation Applied to the Three-level Voltage Inverter”, available at http://icta05.teithe.gr/papers/52.pdf and in H. Pinheiro et al, “Space Vector Modulation for Voltage-Source Inverters: A Unified Approach”, available at http://ieeexplore.ieee.org/xpl/freeabs_all.jisp?arnumber=1187476.

Multilevel and multi-phase inverters comprise a plurality of legs or branches, usually a number of legs or branches corresponding to the number of phases of the electric system, typically three phases and three legs. At the inverter input stage several bulk capacitors are provided with energy storage purpose for correct operation of the machine. The number of bulk capacitors depends upon the number of levels of the inverter.

Each branch or leg of the inverter comprises a number of electronic switches driver by respective driving signals. Switching of the electronic switches causes a flow of electric current across the inverter. FIG. 1B, which will be described in greater detail later on, diagrammatically shows a three-phase, three-level inverter. A0, A1 and A2 are the three branches or legs of the inverter. Each leg or branch contains four electronically driven switches, such as IGTB and respective recirculation diodes, labeled HH_Ai, HL_Ai, LH_Ai, LL_Ai (where i=0, 1, 2). RM_Ai, LM_Ai (i=0, 1, 2) represent the series resistance and inductance of each branch of a generic three-phase load.

At the inverter input a bulk dc-voltage is present, indicated with Vb. The bulk voltage is splitted into two voltage levels by means of two bulk capacitors 3A, 3B. Across each capacitor a voltage of Vb/2 is applied.

If the inverter is perfectly symmetrical, e.g. the voltage drops across the IGBT switches and the IGBT diodes is identical for all the switches in any load condition, the voltage drop across the recirculation diodes is identical for all diodes, etc., and if the three phase load is perfectly balanced (concatenated voltage zero, phase leg impedance is identical for all legs or branches of the load), then the bulk capacitors 3A and 3B remain balanced during operation of the inverter.

However, in real devices and in real applications these ideal symmetrical conditions are not met. Temperature drifts, transient load conditions and other second order effects cause the inverter to be un-symmetrical. Also the differences existing among electronic components of the same type negatively affect the balance of the inverter. Lack of symmetry reflects on the voltages across the bulk capacitors that start to become unbalanced. This can potentially destroy the system or reduce the lifetime of the inverter, if the voltage unbalancing exceeds a threshold value.

It is therefore necessary to compensate for potential unbalances of the bulk capacitors. The correction of unbalanced capacitors is currently done using additional switches which are placed between the bulk capacitors to transfer electric charges differentially and selectively from one capacitor to the other in order to perform a forced balancing correction. These known techniques are simple to implement but have major drawbacks. More specifically, the use of additional switches reduces the overall efficiency of the inverter, since balancing currents will flow through those additional switches. The latter have an efficiency which is necessarily below 100% and therefore at least a fraction of the power flowing through the additional switches will be lost, thus causing a reduction of the overall inverter efficiency. Moreover, the use of additional switches and relevant control circuitry increases the cost of the inverter. The use of additional electronic components reduces the overall reliability of the inverter resulting in a lowering of the MTBF (Mean Time Between Failures) of the inverter. Furthermore, each additional switch must be controlled by analog or digital signals. Computational resources must be available for that purpose on board of the control unit of the inverter.

### SUMMARY OF THE INVENTION

According to one aspect the invention provides an inverter which overcomes or alleviates one or more of the drawbacks of the prior art.

Object of one embodiment of the invention is to provide a multi-level inverter which reduces the problems arising from an unbalancing of the bulk capacitors in a more efficient manner and at minor costs with respect to known inverters.

According to the invention, a rebalancing algorithm will exploit the Space Vector Modulation technique benefits. The core of the invention is the selective control of the power flow among the input capacitors using different vectors in different combinations of the vectors present in the modulation constellation. The combination of this principle with an efficient way of synthesis of the Space Vector Modulation technique makes the balancing action very simple even with a large number of capacitors required by inverters with a high number of voltage levels. The technique of the invention has several important advantages, mainly in terms of overall electrical efficiency and MTBF (Mean Time Between Failures), number and type of power switches employed and voltage output perturbation (output voltage remains unchanged even during the rebalancing action). The technique according to the invention is independent from the power switches topology used to synthesize the multi-level inverter, since the same concepts can be exploited with a simple rearrangement in the constant ROM matrix selection.

According to one aspect, a PWM modulating method of a multiphase inverter is provided, comprising the following steps: calculating a duty cycle vector based on electric parameters defining a rotating vector representing an output electric quantity required from the inverter; detecting actual voltage values across bulk capacitors provided across input terminals of said inverter and modifying the duty cycle vector as a function of said actual voltage values to re-balance said bulk capacitors. According to some embodiments, the duty cycle vector is modified by altering a conduction time of inverter switches during a PWM cycle, such as to modify the voltage across bulk capacitors in an unbalanced condition towards a balanced condition. In a balanced situation, being L the number of voltage levels of the inverter, the same voltage will appear across the (L−1) bulk capacitors, said voltage being Vb/(L−1). If one or more capacitors become unbalanced, the voltage across said capacitors will change. The method of the invention is based on the idea of detecting the voltage across the capacitors during operation of the inverter and calculating correction parameters which, applied to the duty cycle, will alter the conduction time of the inverter switches in order to re-establish a balanced condition. As will become apparent from the following description, a scale factors matrix, i.e. a set of correction parameters, are computed runtime and applied to the duty cycle vector to obtain a corrected duty cycle vector which will then be used to drive the inverter switches. The scale factors are computed such that the power flux across the unbalanced bulk capacitors is altered in such a way that any voltage unbalance will be gradually reduced and eventually eliminated by altering the power flow across the capacitors with respect to the power flow which would normally occur in a balanced condition. More or less power will cause to flow through those bulk capacitors which have too low or two high a voltage drop across them.

According to some embodiments, the method provides for calculating a duty cycle vector as a function of electric parameters defining a rotating vector, e.a. a voltage or a current, required at the output of the inverter. Said duty cycle vector is then multiplied by a scale factors matrix, calculated runtime, containing elements which are a function of the actual voltage values across said bulk capacitors of the inverter, to generate a modified duty cycle vector.

Bulk capacitor rebalancing can be achieved in one or several PWM cycles, depending on the entity of the capacitor unbalancing and on a regulation constant gain.

According to some embodiments, a duty cycle vector is calculated as a function of electric parameters defining the rotating vector; said duty cycle vector is multiplied by a scale factors matrix, containing elements which are a function of said actual voltage values across said bulk capacitors of the inverter, to generate a modified duty cycle vector. If the capacitors are properly balanced, the scale factors matrix will contain only “1” elements and the duty cycle vector will not be modified, altered or corrected.

In some embodiments, the elements of the scale factors matrix are calculated based on the voltage values across the bulk capacitors and a balancing matrix, said balancing matrix containing information on a power flux through each bulk capacitor in each inverter state. In some embodiments the balancing matrices are formed by “0” and “1” digits, wherein: the digit is “0” for each bulk capacitor through which, in the corresponding inverter state, no power flows; the digit is “1” for each bulk capacitor through which, in the corresponding inverter state, power flows.

PWM space vector modulation methods use a set of space vectors to generate the rotating vector representing the required output electric quantity to be provided by the inverter. The space vectors are usually defined by a set of digits defining the inverter state. The quantity of digits depends upon the number of voltage level of the inverter. According to the method disclosed herein, for each state vector, represented by a point in a space vector diagram, a sequence of (L−1) digits is provided, each digit being either a “1” or a “0” and each digit being associated to a bulk capacitor, indicating whether in the inverter state corresponding to the respective space vector, power is flowing through that capacitor. A balancing matrix is thus defined for each point along an axis of the state vectors diagram, each balancing matrix having (L-i) rows and (L−1) columns, where:

L is the number of levels of the inverter, and

0<i<L−1 is the position of the point along the axis.

As will become apparent from the detailed description of some embodiments of the invention, the dimension of the matrix (and more specifically the number of rows thereof) depends on the number of state vectors in each point of the state vector diagram considered.

Further additional features and advantages of the invention are set forth in the dependent claims and in the following detailed description of some exemplary embodiments thereof.

The above brief description sets forth features of the various embodiments of the present invention in order that the detailed description that follows may be better understood and in order that the present contributions to the art may be better appreciated. There are, of course, other features of the invention that will be described hereinafter and which will be set forth in the appended claims. In this respect, before explaining several embodiments of the invention in details, it is understood that the various embodiments of the invention are not limited in their application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which the disclosure is based, may readily be utilized as a basis for designing other structures, methods, and/or systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1A shows a profile of the wave form of a modulating wave and of a carrier wave as well as the PWM signal obtained from the comparison between the carrier wave and the modulating wave;

FIG. 1B shows a diagram of a three-phase three-level inverter for driving an electric motor with star connection (purely by way of example);

FIG. 2 shows a complex plane in which the state vectors of a three-phase three-level inverter are located;

FIG. 3 shows the complex plane of FIG. 2, in which six state vectors, which are discarded in the preferred embodiment of the invention, have been eliminated;

FIG. 4 shows the complex plane of FIG. 3 with a rotating vector, to be obtained at the output of the inverter, in generic position;

FIG. 5 shows the diagram of the three-phase inverter of FIG. 1B with the indication of the switch driving signals and dominant duty cycles;

FIG. 6 shows a block diagram of a system using a three-phase inverter for grid-connected applications that can be controlled using the modulation method of the present invention;

FIG. 7 shows a diagram of a three-phase, four level inverter;

FIG. 8 shows a space vector diagram for the inverter of FIG. 7 where several vectors of the constellations have been eliminated, according to a particularly advantageous embodiment of the invention;

FIG. 9 shows a schematic diagram of the inverter of FIG. 7 in one of the physical states thereof;

FIG. 10 shows an axis of the space vector diagram of FIG. 8 with their relative power triplets

FIG. 11 shows an axis of the space vector diagram of FIG. 8 with their relative power (L−1)-plets in a generic L-level inverter;

FIGS. 12-15 show diagrams explaining the calculation of terms of scale factors used to re-balance the inverter in case of capacitor unbalancing.

### DETAILED DESCRIPTION OF EMBODIMENTS OF THE INVENTION

The following detailed description of the exemplary embodiments refers to the accompanying drawings. The same reference numbers in different drawings identify the same or similar elements. Additionally, the drawings are not necessarily drawn to scale. Also, the following detailed description does not limit the invention. Instead, the scope of the invention is defined by the appended claims.

Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

The following description also contains a detailed description of a particularly advantageous space vector modulation method, which makes the control of the inverter faster and particularly simple from a computational point of view even in case of multi-phase multi-level inverters with a relatively large number of voltage levels.

It should be however understood that the bulk capacitor balancing features of the method disclosed herein can be implemented also in combination with a different space vector modulation method, though the one disclosed herein is particularly advantageous in terms of reduction of computational and storage resources required.

### Space Vector Modulation Theory

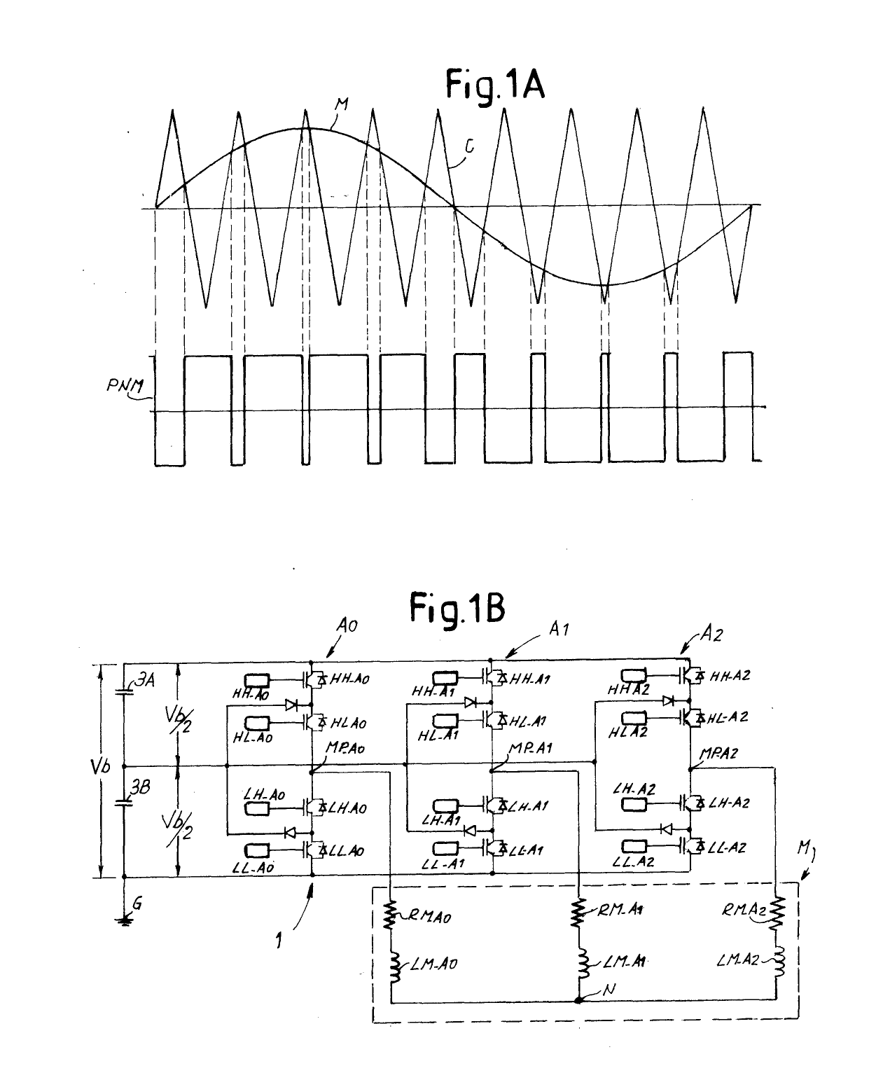

For a better understanding of the present invention, referring to FIGS. 1A and 1B, initially reference will be made to some fundamentals of space vector modulation theory (SVM) applicable to inverters. FIG. 1A shows the profile of the wave form of a carrier wave (C) and the profile of the wave form of a modulating wave (M) that, compared to each other, generate the PWM signal for driving an inverter. By driving the switches of the inverter with a PWM signal of this type, an output voltage is obtained, whose average value within the repetition period of the carrier wave approximates the sinusoidal profile of the modulating wave M.

FIG. 1B, already mentioned, shows a diagram of a three-phase, three-levels PWM inverter 1. The input of the inverter can be connected to a direct voltage source, for example a photovoltaic panel, whilst the output of the inverter can be connected to an electric distribution grid or to a generic three-phase machine to any other kind of three-phase load. As will become apparent here below, the invention can be applied also to a multi-phase system, with more than three phases.

At the input of the inverter 1 a stabilized direct voltage Vb is applied, hereafter indicated as bulk voltage. The bulk voltage is stabilized by two capacitors 3A, 3B. The number of input capacitors depends on the number of voltage levels of the inverter. In the case of an inverter with L levels, the number of input capacitors is L−1. Some alternative embodiments with a different number of voltage levels and capacitors will be described later on. At the terminals of each of the two capacitors 3A, 3B, a voltage equal to ½ Vb is established. The bulk voltage is subdivided into L different levels where L is the order of the multi-level inverter. As known from the prior art, the harmonic content of the inverter output voltage is the smaller (i.e., the output voltage approaches the more closely a sinusoidal wave at the basic frequency, e.g. 50 Hz or 60 Hz), as the order L of the multi-level inverter increases.

In the example of FIG. 1B each leg or branch of the inverter 1 comprises four electronic switches. The three branches are generically indicated with A0, A1, and A2 respectively. The number of electronic switches for each branch o leg is determined by the number of levels of the inverter. For a generic inverter with L levels, the number of switches per phase is 2(L−1). The switches are distributed symmetrically above and below the central point MP_{A0}, MP_{A1}, MP_{A2} of each phase, i.e of each branch or leg.

In the diagram of FIG. 1B, the two switches that are located between the positive terminal and the central point of the respective branch are indicated with HH and HL, whilst those that are located between the central point and the negative terminal are indicated with LH and LL. Hence, the switches of the branch A0 are indicated with HH_A0; HL_A0; LH_A0; LL_A0, whilst those of the branches A1 and A2 are indicated with HH_A1; HL_A1; LH_A1; LL_A1 and respectively HH_A2; HL_A2; LH_A2; LL_A2.

In the illustrated example, the three outputs MP_{A0}, MP_{A1}, MP_{A2} of the inverter supply a balanced three-phase load. In FIG. 1B, this load is a three-phase motor M with an inaccessible neutral N, schematically represented by three branches or legs, each containing a resistance RM_{A0}, RM_{A1}, RM_{A2} and an inductance LM_{A0}, LM_{A1}, LM_{A2} positioned in series. The neutral N is floating relative to the ground G of the inverter 1.

Each electronic switch can be alternatively closed or open. Therefore, since each branch contains four controlled switches, for each branch A0, A₁, A₂ of the three-level inverter 1, in theory 16 different states or conditions are possible, each defined by a different combination of the status (open or closed) of each of the four switches. In general, for an inverter with L levels, theoretically 4(L−1)² states or conditions will be possible.

However, since each state corresponds to a determined condition of electric connection of the inverter, some of these states are inadmissible because they would lead to electrically unacceptable conditions or behaviors of the inverter. Eliminating all these inadmissible states, only the states of a subset of the 16 theoretically definable states are found to be actually compatible with the correct operation of the inverter. It is known from the prior art that for an L-level inverter, there are only L admissible states for each branch. For a generic branch of the three-level inverter of FIG. 1B, these are defined in the following Table 1:

TABLE 1

| | | | | | State number |
|---|---|---|---|---|---|
| | | | | | of the |
| HH State | HL State | LH State | LL State | Vout | branch |
| 1 | 1 | 0 | 0 | +Vb | 2 |
| 0 | 1 | 1 | 0 | +Vb/2 | 1 |
| 0 | 0 | 1 | 1 | 0 | 0 |

Each state is defined by a row of the Table 1. The states of the generic branch (A₀, A₁, A₂) of the inverter 1 are respectively indicated as 2, 1 and 0. The state number is indicated in the last column. The next to last column shows the output voltage with respect to the corresponding point G, and the first four columns show the conditions (open=0 or closed=1) of the four switches. The four conditions of the four switches indicated in a single row define the state (0, 1 or 2) of the branch of the inverter. The switch is identified by the acronym HH, HL, LH, LL in the header of the table. Thus for example the first row indicates that in the state “2” of a generic branch of the inverter 1 the switches between the positive terminal and the central point MP (in the case of the branch A₀ the switches HH A₀, HL_A₀) are closed, whilst the switches between the negative terminal and the central point (in the case of the branch A₀, the switches LH_A₀ and LL_A₀) are open.

There is a relationship between the output voltage of a generic branch of the inverter with respect to the point G and the state (0, 1, 2) taken by the branch. In the case of a three-level inverter, there are three possible values of the output voltage (0, ½Vb and Vb) for the three states 0, 1 and 2, respectively. This relationship can be generalized. For a generic L-levels inverter it can be demonstrated that the output voltage Vout(i) relative to the point G for the generic state “i” of the inverter is given by:

$$Vout ( i ) = Vb * \frac{i}{L - 1} \\ where \text{:} \\ 0 \leq i \leq L - 1 \qquad ( 1 )$$

Moreover, it can easily be demonstrated that inside each of the three branches A₀, A₁, A₂ the state of the switch LH is the negation of the state of the switch HH and the state of the switch LL is the negation of the state of the switch HL. This can be briefly indicated as follows:

LH=NOT(HH)

LL=NOT(HL) (2)

In fact, referring to Table 1 above, when the switch HH is closed (state 1), the switch LH is open (state 0) and vice versa. Similarly, when the switch LL is closed the switch HL is open and vice versa.

Therefore, since there is a relationship between the states of pairs of switches, although in theory four variables are necessary to define the state of the branch (one variable for each of the four switches), in fact two variables for each branch are sufficient. These variables can be associated to the driving signals of only the switches HH and HL respectively. The driving signals of the switches LH and LL are derived from those of the switches HH and HL on the basis of the aforesaid logic negation relationship.

This property also holds true for an inverter that has a generic number of levels L. The state of each branch of such a generic L-level inverter can be defined by L−1 variables.

Hereafter, these variables for the example of three-phase three-level inverter shall be indicated as S₀_{_{—}}ₓe S₁_{_{—}}ₓ, where the subscript x identifies the branch A₀, A₁, A₂. Hence, the state of a generic branch x of the inverter is defined by a two-dimension vector S_x=(S₀_{_{—}}ₓ; S₁_{_{—}}ₓ). For an L-level inverter, vice versa, there will be L−1 variables for each branch x

S_{—}x=(S₀_{_{—}}ₓ,S₁_{_{—}}ₓ, . . . ,S_{L-2}_{_{—}}ₓ) (3)

In view of these considerations, the conclusion is that a three-phase inverter can be described by a state vector having the following form:

(A₀,A₁,A₂) (4)

where each component A₀, A₁, A₂ of the vector indicates the state of one of the three branches of the inverter. As noted above, each component can take a value 0, 1 or 2 that corresponds to one of the three states indicated in Table 1. For example for the inverter of FIG. 1B the vector

(A₀,A₁,A₂)=1,0,0 (5)

indicates the following condition of the switches in the three branches:

(HH_{—}A₀,HL_{—}A₀,LH_{—}A₀,L_{—}A₀,HH_{—}A₁,HL_{—}A₁,LH_{—}A₁,LL_{—}A₁,HH_{—}A₂,HL_{—}A₂,LH_{—}A₂,LL_{—}A₂)==(0,1,1,0,0,0,1,1,0,0,1,1) (6)

As is readily apparent from Table 1 above, the output voltage, on the central point MP_{A0}, MP_{A1}, MP_{A2} of the three branches with respect to the point G is equal to:

Vout_{A}_{₀}=Vb/2

Vout_{A}_{₁}=0

Vout_{A2}=0 (7)

These considerations can be generalized to a three-phase L-levels inverter, for the following output voltages with respect to the point G can be defined (wherein (i_{A0}, i_{A1}, i_{A2}) indicate the state vector that describes the entire inverter):

$${Vout}_{{A}_{0}} = Vb * \frac{{i}_{{A}_{0}}}{L - 1} \\ {Vout}_{{A}_{1}} = Vb * \frac{{i}_{{A}_{1}}}{L - 1} \\ {Vout}_{{A}_{2}} = Vb * \frac{{i}_{{A}_{2}}}{L - 1} \qquad ( 8 )$$

The three output voltages power a balanced three-phase load and hence the concatenated voltage is equal to zero. I.e.:

$${V}_{{A}_{0 \_} N} + {V}_{{A}_{1 \_} N} + {V}_{{A}_{2 \_} N} = 0 \qquad ( 9 )$$

where V_{Ai}_{_{—}}_{N} indicates the voltage across the neutral of the load (indicated as point N in FIG. 1B) and the output of the generic phase “i” of the inverter. Hence, considering the common mode voltage between the ground G and the neutral N (V_{GND}_{_{—}}_{N}), the following is obtained:

$${V}_{{A}_{0 \_} N} = {Vout}_{{A}_{0}} + {V}_{GND\_N} \\ {V}_{{A}_{1 \_} N} = {Vout}_{{A}_{1}} + {V}_{GND\_N} \\ {V}_{{A}_{2 \_} N} = {Vout}_{{A}_{2}} + {V}_{GND\_N} \qquad ( 10 )$$

Summing these three equations and using the property of null concatenation expressed by equation (9), the following is obtained:

$${V}_{GND \_ N} = - \frac{{Vout}_{{A}_{0}} + {Vout}_{{A}_{1}} + {Vout}_{{A}_{2}}}{3} \qquad ( 11 )$$

and substituting the output voltage of each phase with its expression as a function of the bulk voltage Vb and of the state “i”, the following is obtained:

$${V}_{GND \_ N} = - \frac{Vb}{3 * ( L - 1 )} ( {i}_{{A}_{0}} + {i}_{{A}_{1}} + {i}_{{A}_{2}} ) \qquad ( 12 )$$

Therefore, the voltages across the output of each phase and the neutral point N are:

$${V}_{{A}_{0 \_ N}} = \frac{Vb}{3 * ( L - 1 )} * ( 2 * {i}_{{A}_{0}} - {i}_{{A}_{1}} - {i}_{{A}_{2}} ) \\ {V}_{{A}_{1 \_ N}} = \frac{Vb}{3 * ( L - 1 )} * ( 2 * {i}_{{A}_{1}} - {i}_{{A}_{0}} - {i}_{{A}_{2}} ) \\ {V}_{{A}_{2 \_ N}} = \frac{Vb}{3 * ( L - 1 )} * ( 2 * {i}_{{A}_{2}} - {i}_{{A}_{0}} - {i}_{{A}_{1}} ) \qquad ( 13 )$$

Summarizing, the voltage across each phase of the inverter and the neutral of the load can be expressed as a function of the bulk voltage Vb and of the state (i_{A0}, i_{A1}, i_{A2}) of each branch of the inverter, which in the case of the three-level inverter of FIG. 1 can take the values 0, 1, 2 alternatively for each phase.

This set of three voltage values for the three phases can be represented with a vector representation applying the Clarke transform. The in-phase and quadrature components of the voltage vector that is obtained applying the Clarke transform, are:

$${V}_{α} = k * ( {V}_{{A}_{0} \_ N} - \frac{{V}_{{A}_{1} \_ N} + {V}_{{A}_{2} \_ N}}{2} ) \\ {V}_{β} = k * \frac{\sqrt{3}}{2} * ( {V}_{{A}_{1 \_ N}} - \frac{{V}_{{A}_{1 \_ N}} + {V}_{{A}_{2 \_ N}}}{2} ) \qquad ( 14 )$$

and applying the expressions of the voltages across phase and neutral expressed as a function of the states of the three phases of the inverter, the following is obtained:

$${V}_{α} = \frac{Vb}{L - 1} ( {i}_{{A}_{0}} - \frac{{i}_{{A}_{1}} + {i}_{{A}_{2}}}{2} ) \\ {V}_{β} = \frac{\sqrt{3}}{2} \frac{Vb}{L - 1} * ( {i}_{{A}_{1}} - {i}_{{A}_{2}} ) \qquad ( 15 )$$

having selected k=11 in order to have a mathematical transformation that maintains the modules of the voltages.

In the general case of an L-level inverter, the above equations lead to define L³ different vectors, some of which, however, coincide with each other in the complex plane. In the case of a three-level inverter, the 27 (3³) vectors are reduced to 19 different vectors.

In general, it can be demonstrated that in the complex plane for a generic three-phase L-level inverter a number of effective, i.e. mutually different, vectors is identified, defined by

SVM_{—}Vec_{—}Num=3*L*(L−1)+1 (16)

and for L=3 (three-level inverter), the vectors are limited to 19.

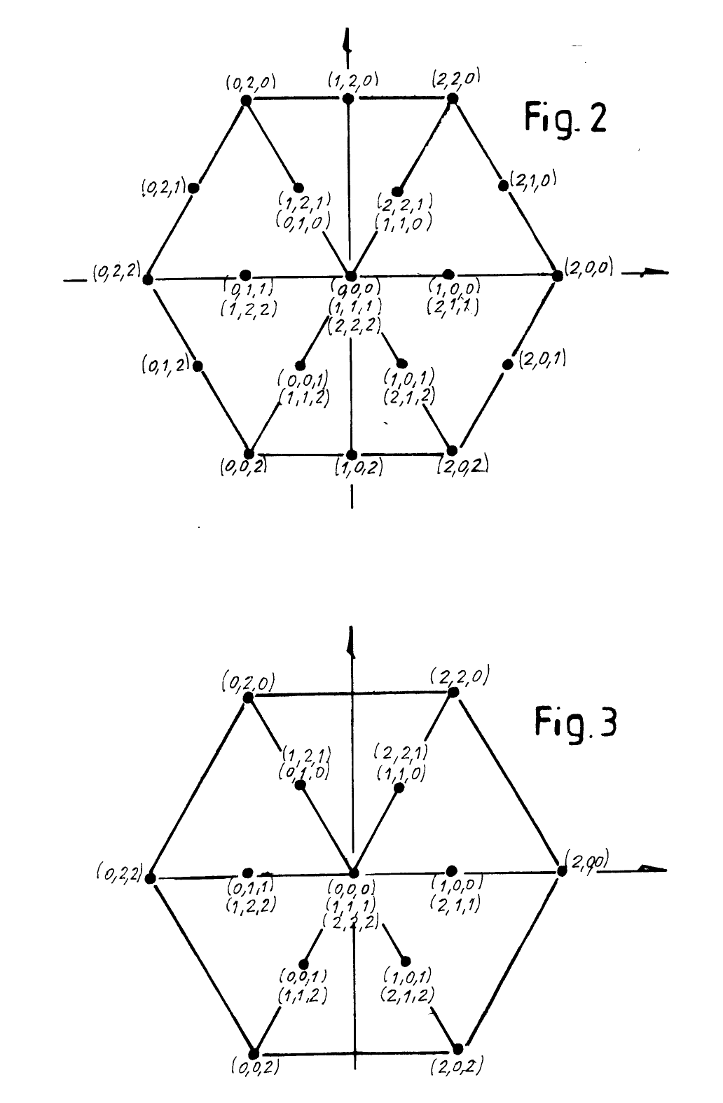

FIG. 2 shows the complex plane in which the 27 state vectors that define the conditions of the three-phase three-level inverter are represented. In practice, the diagram shows 27 points of the complex plane that represent the end of as many vectors, each of which represents the output voltage of the inverter relative to the neutral N when it takes a condition defined by the set of three values (so-called “state triplet”) indicated in parentheses next to each point, where each set of three is defined in (4), and each component of a set of three represents the pair of values (S₀_{_{—}}ₓ; S₁_{_{—}}ₓ) defined in (3).

It is noted that, as indicated above, the number of mutually different vectors is lower than the number of states of the inverter and that the total number of mutually distinct vectors is 19.

### Application of a Novel SVM to a Three-Phase, Three-Level Inverter

Starting from what has been summarized so far, which is known from the prior art and constitutes the theory on which the space vector modulation (SVM) of the inverter is based, in a particularly advantageous embodiment the number of vectors in the complex plane that are used for modulation can be reduced. More in particular, observing that all vectors are located on rays or axes which are shifted from one another by 60 electric degrees, except the vectors represented by the state triplets (2,1,0), (0,2,1), (0,1,2), (2,0,1), (1,2,0), (1,0,2) these six vectors will be eliminated (see FIG. 2 in this regard).

FIG. 3 represents in the complex plane the 21 vectors that will be used in this preferred embodiment of the method. This choice does not set particular limitations, because the vectors that represent the output voltage of the inverter are all those that are inside the circle inscribed in the hexagon represented in the diagram of FIG. 3, which can provide the highest possible modulation index.

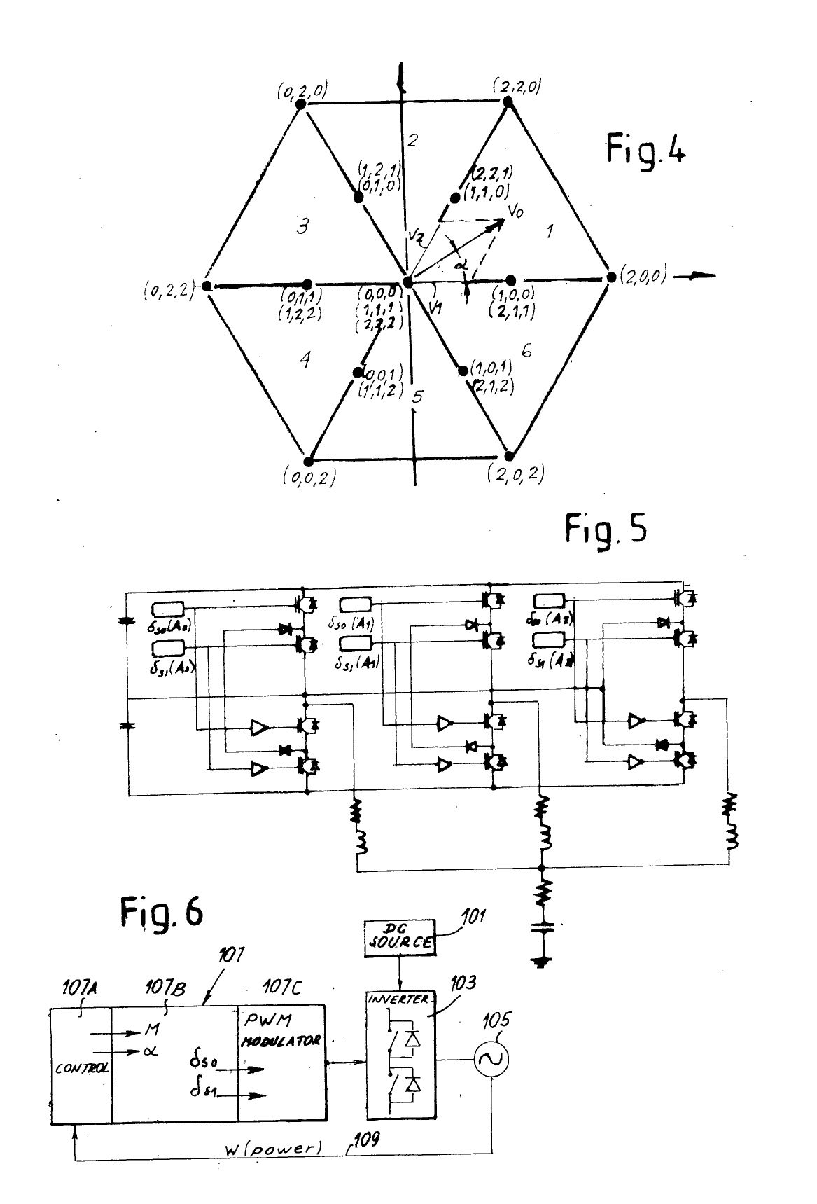

In the diagram of FIG. 3, six sectors can be identified, each of which spans over 60 electric degrees. The six sectors are indicated in FIG. 4 and numbered from 1 to 6.

Now consider the rotating vector V₀ in the diagram of FIG. 4, which represents the three-phase voltage output from the inverter 1 after the application of the Clarke transform. The rotating vector V₀ can be associated to one of the sectors into which the diagram is subdivided. Preferably, the rotating vector is associated to the sector inside which it is located. For example, in the state of FIG. 4 the rotating vector V₀ is associated to sector no. 1.

The rotating vector V₀ can be projected on the edges of the relevant sector, in order to identify the two components V₁ and V₂ of the rotating vector V₀, i.e. the two projections of the rotating vector on the axes that delimit the sector in which the rotating vector V₀ is located in the instant considered. On the basis of simple trigonometric considerations, being α the angle between the rotating vector and the positive half of the abscissa axis, as indicated in FIG. 4, the following relationships are obtained:

$$\begin{matrix}{V}_{1} = \frac{MVb}{2} * ( \sqrt{3} cos α - sin α ) \\ {V}_{2} = MVb * sin α\end{matrix} where \text{:} M = \frac{2}{\sqrt{3}} \frac{{V}_{o}}{Vb} \qquad ( 17 )$$

The quantity M indicates the ratio between the amplitude of the rotating vector and the bulk voltage Vb and represents the modulation index which may vary between 0 and 1, value which is taken when the rotating vector V₀ has one end thereof on the circumference inscribed in the hexagon of FIG. 4. This condition corresponds to the maximum output voltage across phase and neutral N equal to

$$\frac{\sqrt{3}}{2} Vb$$

and phase-phase voltage equal to Vb.

The rotating vector V₀ is then obtained synthesizing in each instant the components V₁, V₂ of the vector on the axes defining the sector in which the rotating vector V₀ is located instantaneously, modulating the opening and the closing of the electronic switches of the three branches of the inverter. Since each switching condition of the switches of the inverter corresponds to one of the states represented by the 21 vectors shown in the complex plane of FIG. 4, essentially to obtain the voltage represented by the rotating vector V₀ it is necessary adequately to combine the states of the inverter, to obtain the components V₁, V₂ of the rotating vector V₀.

With reference to the instant represented in FIG. 4, the vector V₁ can be synthesized using various possible combinations of the state vectors (2,0,0), (1,0,0) and (2,1,1). In particular, the vector V₁ can be obtained with one of the following combinations:
1. using only the vector (2,0,0) applied for a duty cycle of

$${δ}_{1} = \frac{{V}_{1}}{Vb}$$

2. using only the vector (1,0,0) (only if

$$\vert {V}_{o} \vert \leq \frac{Vb}{2} )$$

applied for a duty cycle equal to

$${δ}_{1} = \frac{{V}_{1}}{Vb / 2}$$

3. using only the vector (2,1,1) (only if

$$\vert {V}_{o} \vert \leq \frac{Vb}{2} )$$

applied for a duty cycle equal to

$${δ}_{1} = \frac{{V}_{1}}{Vb / 2}$$

4. using the vectors (2,0,0) and (1,0,0) and (2,1,1) in linear combination.

To obtain the maximum performance in terms of harmonic content and uniformity of the switching signal, in a preferred embodiment the method according to the invention uses the linear combination of the three vectors (2,0,0), (1,0,0) and (2,1,1). More in particular, in preferred embodiments of the invention the vector (2,0,0) is used to accomplish half of the projection of the vector V₁, and the vectors (1,0,0) and (2,1,1) each to accomplish one fourth of the remaining projection.

The duty cycles associated to this choice are the following:

$$\begin{matrix}\begin{matrix}( 2 , 0 , 0 ) \to {δ}_{1}^{1} = \frac{{V}_{1}}{2} \frac{1}{Vb} \\ ( 1 , 0 , 0 ) \to {δ}_{1}^{2} = \frac{{V}_{1}}{4} \frac{1}{Vb / 2} = \frac{{V}_{1}}{2} \frac{1}{Vb}\end{matrix} \\ ( 2 , 1 , 1 ) \to {δ}_{1}^{3} = \frac{{V}_{1}}{4} \frac{1}{Vb / 2} = \frac{{V}_{1}}{2} \frac{1}{Vb}\end{matrix} \qquad ( 18 )$$

Note that the three duty cycles have the same value, which will be indicated as δ₁.

Similar considerations can be made for the component V₂, obtaining the following duty cycle values to synthesize the vector V₂:

$$\begin{matrix}\begin{matrix}( 2 , 2 , 0 ) \to {δ}_{2}^{1} = \frac{{V}_{2}}{2} \frac{1}{Vb} \\ ( 1 , 1 , 0 ) \to {δ}_{2}^{2} = \frac{{V}_{2}}{4} \frac{1}{Vb / 2} = \frac{{V}_{2}}{2} \frac{1}{Vb}\end{matrix} \\ ( 2 , 2 , 1 ) \to {δ}_{2}^{3} = \frac{{V}_{2}}{4} \frac{1}{Vb / 2} = \frac{{V}_{2}}{2} \frac{1}{Vb}\end{matrix} \qquad ( 19 )$$

In this case, too, the three duty cycles have the same value, which will be indicated with δ₂.

To assure the physical coherence of the projection in the vector space, the residual time (if existing) of the PWM cycle is assigned to the vectors (0,0,0), (1,1,1) and (2,2,2) as follows:

$${δ}_{3} = \frac{1 - {V}_{1} - {V}_{2}}{3} \\ ( 0 , 0 , 0 ) \to {δ}_{3} \\ ( 1 , 1 , 1 ) \to {δ}_{3} \\ ( 2 , 2 , 2 ) \to {δ}_{3} \qquad ( 20 )$$

With a simple substitution of (17) in (18), (19) and (20) and remembering that the modulation index M is equal to Vₒ/V_{b}, the following is obtained:

$${δ}_{1} = \frac{M}{4} ( \sqrt{3} cos α - sin α ) ; \\ {δ}_{2} = \frac{M}{2} sin α ; \\ {δ}_{3} = \frac{1}{3} - \frac{M}{6} ( \sqrt{3} cos α + sin α ) \qquad ( 21 )$$

Briefly, this means that in a given PWM cycle, to generate the vector V₀ the nine vectors representing nine states of the inverter are combined; they are identified by the vectors (2,0,0); (1,0,0); (2,1,1); (0,0,0); (1,1,1); (2,2,2); (2,2,0); (2,2,1); (1,1,0), i.e. the vectors that are located on the two axes that in the complex plane (FIG. 3) define the sector in which the rotating vector V₀ is located. Each of these vectors corresponds to a state triplet of the inverter and each state triplet identifies for each branch of the three-phase inverter the state assumed by the four switches of the branch. The three duty cycle values δ₁, δ₂, δ₃ are those obtained from the above formulas (19), (20) and (21).

From what has been described above with respect to the modulation theory, see in particular Table 1, it has been seen that for a three-phase, three-level inverter, two variables are sufficient for each phase in order to obtain the correct driving of the inverter switches, which variables can be associated to the driving signals of the switches HH and HL respectively. From Table 1, associating to each state number Aₓ the respective variables S₀_{_{—x}} and S₁_{_{—}}ₓ, the following relationship between the state number and the state variables is obtained

TABLE 2

| State number for the generic branch Aₓ | Variable S₀_{_{—}}ₓ | Variable S₁_{_{—}}ₓ |
|---|---|---|
| 0 | 0 | 0 |
| 1 | 0 | 1 |
| 2 | 1 | 1 |

In a three-phase inverter, three tables of this kind can be written, one for each branch of the inverter. This means that two vectors with three components each can be associated to each state (A₀, A₁, A₂) of the inverter. For example, for the state (A₀, A₁, A₂)=(2,0,0), the following is obtained

(2,0,0)→ S̅₀=(1,0,0) S̅₁=(1,0,0) (22A)

and for the state (A₀, A₁, A₂)=(2,1,1), the following is obtained

(2,1,1)→ S̅₀=(1,0,0) S̅₁=(1,1,1) (22B)

Returning to the vector representation of FIG. 4, the nine vectors lying on the axes defining the sector 1 (between 0 and 60 degrees) used to calculate the projections of the rotating vector V₀ can be described by the following vector system:

(2,0,0)→ S̅₀=(1,0,0) S̅₁=(1,0,0)

(1,0,0)→ S̅₀=(0,0,0) S̅₁=(1,0,0)

(2,1,1)→ S̅₀=(1,0,0) S̅₁=(1,1,1)

(2,2,0)→ S̅₀=(1,1,0) S̅₁=(1,1,0)

(1,1,0)→ S̅₀=(0,0,0) S̅₁=(1,1,0)

(2,2,1)→ S̅₀=(1,1,0) S̅₁=(1,1,1)

(0,0,0)→ S̅₀=(0,0,0) S̅₁=(0,0,0)

(1,1,1)→ S̅₀=(0,0,0) S̅₁=(1,1,1)

(2,2,2)→ S̅₀=(1,1,1) S̅₁=(1,1,1) (23)

The 18 vectors with dimensions 1×3 shown in (23) above can be rewritten in the form of two matrices with dimensions 9×3 in the following way, simply collecting row by row the vectors S̅ₒ and S̅₁ obtained above:

$${S}_{0 \_M} = [ \begin{matrix}1 & 0 & 0 \\ 0 & 0 & 0 \\ 1 & 0 & 0 \\ 1 & 1 & 0 \\ 0 & 0 & 0 \\ 1 & 1 & 0 \\ 0 & 0 & 0 \\ 0 & 0 & 0 \\ 1 & 1 & 1\end{matrix} ] \\ {S}_{1 \_ M} = [ \begin{matrix}1 & 0 & 0 \\ 1 & 0 & 0 \\ 1 & 1 & 1 \\ 1 & 1 & 0 \\ 1 & 1 & 0 \\ 1 & 1 & 1 \\ 0 & 0 & 0 \\ 1 & 1 & 1 \\ 1 & 1 & 1\end{matrix} ] \qquad ( 24 )$$

These two matrices will be defined as modulation matrices for the first sector of the complex plane. A duty cycle vector D with dimension 1×9 is then defined, as follows

D=[δ₁δ₁δ₁δ₂δ₂δ₂δ₃δ₃δ₃] (25)

where it was seen that

$${δ}_{1} = \frac{M}{4} ( \sqrt{3} cos α - sin α ) \\ {δ}_{2} = \frac{M}{2} sin α \\ {δ}_{3} = \frac{1}{3} - \frac{M}{6} ( \sqrt{3} cos α + sin α ) \qquad ( 26 )$$

It can be observed that the duty cycles to be applied to the modulator of the inverter can be calculated as row by column products between the vector D and the modulation matrices S₀_{_{—}}_{M} and S₁_{_{—}}_{M} as follows:

δ_{S}_{₀}=D·S₀_{_{—}}_{M}δ_{S}_{₁}=D·S₁_{_{—}}_{M} (27)

obtaining two vectors with dimensions 1×3. The first component of the vector so is given by the sum of the products of each of the nine components of the duty cycle vector D for the first column of the matrix S₀_{_{—}}_{M}, the second component is given by the product of each component of the vector D for each component of the second column of the matrix and the third component is given by the sum of the products of each component of the vector D for the corresponding component of the third column of the matrix. A similar definition applies to the second vector δ_{S1} with dimensions 1×3 that is obtained multiplying the vector D times the second modulation matrix.

The vector δ_{S0} contains the duty cycle values for the switches HH of the three branches A₀, A₁, A₂ of the inverter, and δ_{S1} contains the duty cycle values of the switches HL of the three branches A₀, A₁, A₂ of the inverter, as schematically indicated in FIG. 5, which represents how the values of the duty cycles described above are applied to the switches of the three-phase three-level inverter. This figure also indicates the driving signals for the switches LH and LL obtained by negation of the signals to the switches HH and HL.

What is described above for the first of the six 60-degree sectors into which the complex plane is divided can be repeated for the remaining sectors indicated with 2, 3, 4, 5, 6 in FIG. 4. The following Table 3 collects the two matrices S₀_{_{—}}_{M} and S₁_{_{—}}_{M} for each of the six sectors identified in the complex plane:

TABLE 3

| Sector number | matrix S₀_M | matrix S₁_M |
|---|---|---|
| 1 | $[ \begin{matrix}1 & 0 & 0 \\ 0 & 0 & 0 \\ 1 & 0 & 0 \\ 1 & 1 & 0 \\ 0 & 0 & 0 \\ 1 & 1 & 0 \\ 0 & 0 & 0 \\ 0 & 0 & 0 \\ 1 & 1 & 1\end{matrix} ]$ | $[ \begin{matrix}1 & 0 & 0 \\ 1 & 0 & 0 \\ 1 & 1 & 1 \\ 1 & 1 & 0 \\ 1 & 1 & 0 \\ 1 & 1 & 1 \\ 0 & 0 & 0 \\ 1 & 1 & 1 \\ 1 & 1 & 1\end{matrix} ]$ |
| 2 | $[ \begin{matrix}1 & 1 & 0 \\ 0 & 0 & 0 \\ 1 & 1 & 0 \\ 0 & 1 & 0 \\ 0 & 0 & 0 \\ 0 & 1 & 0 \\ 0 & 0 & 0 \\ 0 & 0 & 0 \\ 1 & 1 & 1\end{matrix} ]$ | $[ \begin{matrix}1 & 1 & 0 \\ 1 & 1 & 0 \\ 1 & 1 & 1 \\ 0 & 1 & 0 \\ 0 & 1 & 0 \\ 1 & 1 & 1 \\ 0 & 0 & 0 \\ 1 & 1 & 1 \\ 1 & 1 & 1\end{matrix} ]$ |
| 3 | $[ \begin{matrix}0 & 1 & 0 \\ 0 & 0 & 0 \\ 0 & 1 & 0 \\ 0 & 1 & 1 \\ 0 & 0 & 0 \\ 0 & 1 & 1 \\ 0 & 0 & 0 \\ 0 & 0 & 0 \\ 1 & 1 & 1\end{matrix} ]$ | $[ \begin{matrix}0 & 1 & 0 \\ 0 & 1 & 0 \\ 1 & 1 & 1 \\ 0 & 1 & 1 \\ 0 & 1 & 1 \\ 1 & 1 & 1 \\ 0 & 0 & 0 \\ 1 & 1 & 1 \\ 1 & 1 & 1\end{matrix} ]$ |
| 4 | $[ \begin{matrix}0 & 1 & 1 \\ 0 & 0 & 0 \\ 0 & 1 & 1 \\ 0 & 0 & 1 \\ 0 & 0 & 0 \\ 0 & 0 & 1 \\ 0 & 0 & 0 \\ 0 & 0 & 0 \\ 1 & 1 & 1\end{matrix} ]$ | $[ \begin{matrix}0 & 1 & 1 \\ 0 & 1 & 1 \\ 1 & 1 & 1 \\ 0 & 0 & 1 \\ 0 & 0 & 1 \\ 1 & 1 & 1 \\ 0 & 0 & 0 \\ 1 & 1 & 1 \\ 1 & 1 & 1\end{matrix} ]$ |
| 5 | $[ \begin{matrix}0 & 0 & 1 \\ 0 & 0 & 0 \\ 0 & 0 & 1 \\ 1 & 0 & 1 \\ 0 & 0 & 0 \\ 1 & 0 & 1 \\ 0 & 0 & 0 \\ 0 & 0 & 0 \\ 1 & 1 & 1\end{matrix} ]$ | $[ \begin{matrix}0 & 0 & 1 \\ 0 & 0 & 1 \\ 1 & 1 & 1 \\ 1 & 0 & 1 \\ 1 & 0 & 1 \\ 1 & 1 & 1 \\ 0 & 0 & 0 \\ 1 & 1 & 1 \\ 1 & 1 & 1\end{matrix} ]$ |
| 6 | $[ \begin{matrix}1 & 0 & 1 \\ 0 & 0 & 0 \\ 1 & 0 & 1 \\ 1 & 0 & 0 \\ 0 & 0 & 0 \\ 1 & 0 & 0 \\ 0 & 0 & 0 \\ 0 & 0 & 0 \\ 1 & 1 & 1\end{matrix} ]$ | $[ \begin{matrix}1 & 0 & 1 \\ 1 & 0 & 1 \\ 1 & 1 & 1 \\ 1 & 0 & 0 \\ 1 & 0 & 0 \\ 1 & 1 & 1 \\ 0 & 0 & 0 \\ 1 & 1 & 1 \\ 1 & 1 & 1\end{matrix} ]$ |

The twelve matrices with dimension 9×3 in Table 3 are called modulation matrices for a three-phase three-level inverter.

Ultimately, therefore, to obtain at the output of the inverter a three-phase voltage that can be represented as a rotating vector V₀ with module

$$M = \frac{2}{\sqrt{3}} \frac{{V}_{o}}{Vb} \qquad ( 28 )$$

it is sufficient to calculate for each PWM cycle the products between the vector D of the duty cycle and the two matrices with dimensions 9×3 corresponding to the sector in which the rotating vector is positioned at a given instant, determined by the electric angle α formed in that instant between the rotating vector V₀ and the vector of the sector within which lies the vector V₀ to be synthesized that is closest to the axis of the abscissa of the complex plane. Multiplying the vector of the duty cycle D, with dimension 1×9, and the two 9×3 modulation matrices corresponding to the sector in which the rotating vector is located, the duty cycle values are obtained which shall be applied to the six switches HH, HL (two for each branch) of the inverter, whilst the driving variables of the remaining six switches LH, LL are obtained as the negation of the control variables of HH and HL. A carrier-based PWM modulator receives at its input the duty cycle values and transforms them directly into on/off signals for the various switches of the various branches of the inverter, obtaining the desired three-phase voltage output.

In principle, the method according to the invention could be implemented by storing the twelve modulation matrices defined in the Table 3 in a memory support associated to the controller for driving the inverter. However, as will be clarified now, the quantity of information to be stored can in fact be far smaller, with advantages in terms of reduction of the memory employed and of the computational loads.

In fact, it is observed that the matrices of Table 3 are redundant. This redundancy can be exploited to speed up the execution of the calculation of the row times columns product. Each column of a generic 9×3 modulation matrix of Table 3 can be considered a representation of a binary number, whose least significant bit (LSB) is the one in the last position, i.e. in the ninth row, as indicated below for example for the matrix S₀_{_{—}}_{M} of the first sector

$$LSB \to [ \begin{matrix}1 & 0 & 0 \\ 0 & 0 & 0 \\ 1 & 0 & 0 \\ 1 & 1 & 0 \\ 0 & 0 & 0 \\ 1 & 1 & 0 \\ 0 & 0 & 0 \\ 0 & 0 & 0 \\ 1 & 1 & 1\end{matrix} ] \qquad ( 29 )$$

Hence, each matrix with dimensions 9×3 corresponds to a 1×3 matrix containing three numbers in decimal notation. The S₀_{_{—}}_{M} of the first sector corresponds for example to the following 1×3 matrix:

[361,41,1] (30)

Applying this principle and then transforming each column of the twelve modulation matrices of Table 3 in corresponding matrices 1×3 of numbers in decimal notation, the following Table 4 is obtained:

TABLE 4

| Sector number | matrix R₀_{_{—}}_{M} | matrix R₁_{_{—}}_{M} |
|---|---|---|
| 1 | [361 41 1] | [507 123 75] |
| 2 | [321 361 1] | [459 507 75] |
| 3 | [1 361 41] | [75 507 123] |
| 4 | [1 321 361] | [75 459 507] |
| 5 | [41 1 361] | [123 75 507] |
| 6 | [361 1 321] | [507 75 459] |

These matrices constitute the modulation matrices compressed in decimal format. While the possibility of expressing the modulation matrices in decimal notation enormously simplifies the code writing and programming operations, at the end it does not influence what happens in the control system that, based on the modulation method described herein, drives the inverter.

It is now observed that in three of the six modulation matrices in decimal format R₀_{_{—}}_{M}, the same set of three numbers 361, 321, 1 is always found, and in the other three matrices R₀_{_{—}}_{M} the set of three numbers 361, 1, 41 is found. What changes is the sequence of the numbers of the set. Similar considerations hold true for the matrices R₁_{_{—}}_{M}. To exploit this additional redundancy present in the matrices thus obtained, the following operation of rotation of a vector with dimensions 1×N is defined. Given a vector

X=[X₁X₂ . . . X_{N}] (31)

its rotation ROT(X,1) is the circular shift of the vector by one position to the right. I.e.:

ROT(X,1)=[X_{N}X₁ . . . X_{N-1}] (32)

In a similar manner, for the same vector the rotation ROT(X,-1) is defined as the circular shift of the vector by one position to the left:

ROT(X,−1)=[X₂X₃ . . . X₁] (33)

A multiple rotation by M positions (where the rotation is rightwards if M is positive and leftwards if M is negative) can be seen as a sequence of M consecutive rotations by one bit, i.e. by one position.

Having stated this, and having thus defined the operation of rotating the matrix 1×N, observing Table 4 it is noted that

$$\{ \begin{matrix}{R}_{X\_M} ( 3 ) = ROT ( {R}_{X\_M} ( 1 ) , 1 ) \\ {R}_{X\_M} ( 5 ) = ROT ( {R}_{X\_M} ( 1 ) , 2 )\end{matrix} \\ \{ \begin{matrix}{R}_{X\_M} ( 4 ) = ROT ( {R}_{X\_M} ( 2 ) , 1 ) \\ {R}_{X\_M} ( 6 ) = ROT ( {R}_{X\_M} ( 2 ) , 2 )\end{matrix} \\ where \text{:} X ∈ \{ 0 , 1 \} \qquad ( 34 )$$

This means that the third matrix R_{X}_{_{—}}_{M}(3) can be obtained from the first matrix R_{X}_{_{—}}_{M}(1) rotating by one position, whilst the fifth matrix R_{X}_{_{—}}_{M}(5) can be obtained from the first matrix rotating it by two positions. The matrix R_{X}_{_{—}}_{M}(4) and the matrix R_{X}_{_{—}}_{M}(6) are obtained rotating the second matrix R_{X}_{_{—}}_{M}(2) respectively by one and two positions.

Therefore, it is possible to define four compressed (non redundant) modulation matrices, which define the modulation of the inverter; they are defined by the matrices R₀_{_{—}}_{M}(1), R₀_{_{—}}_{M}(2), R₁_{_{—}}_{M}(1) and R₁_{_{—}}_{M}(2) with dimensions 1×3:

TABLE 5

| vector no. (X) | matrix Rₓ_{_{—}}_{M} (1) | matrix Rₓ_{_{—}}_{M} (2) |
|---|---|---|
| 0 | [361 41 1] | [507 123 75] |
| 1 | [321 361 1] | [459 507 75] |

From these matrices, the remaining matrices can be obtained simply by means of rotation operations as defined above. These four compressed modulation matrices can be stored in a ROM memory with the following conventional notation

$${Y}_{0 \_ M} = [ \begin{matrix}{R}_{0 \_ M} ( 2 ) \\ {R}_{0 \_ M} ( 1 )\end{matrix} ] \\ {Y}_{1 \_ M} = [ \begin{matrix}{R}_{1 \_ M} ( 2 ) \\ {R}_{1 \_ M} ( 1 )\end{matrix} ] \qquad ( 35 )$$

Decompressing the compressed modulation matrices with operations that are inverse to those described above (rotation and conversion from decimal to binary), the matrices of Table 3 are obtained, which, multiplied by the vector D of the duty cycles provide the two control variables of the switches HH and HL of each branch of the inverter in the six sectors into which the complex plane is divided. The control variables of the switches LH and LL are obtained as the negation of the previous ones.

The memory space required to store the data of the compressed modulation matrices for the example of the three-phase three-level modulator is 108 bit, as opposed to a space of 324 bit that would be necessary to store the same data without making recourse to rotation. This is a substantial advantage from a view point of the reduction of the memory space required for the driving of the inverter.

Moreover, the rotation operation defined above is substantially a “circular buffering” that is the simplest software technique for collecting data in digital systems. Some microprocessors have in their machine code the instructions for this rotation operation which therefore can be carried out with a single command.

The vector modulation of the inverter can use these compressed modulation matrices and, applying an inverse rotation operation, it enables to calculate for each PWM cycle the driving variables of the twelve switches of the inverter in such a way as to obtain at the output the three-phase voltage represented by the rotating vector V₀.

The organization in binary numbers is useful for the digital implementation, because the row-column product can be seen as a binary masking action rather than as a traditional product operation. The microprocessors and the DSPs usually have native instructions in their machine code to carry out binary masking. This further reduces the computational loads required to drive the inverter.

Application of the New SVM Method to Inverters with Four and Five Voltage Levels

Based on computations similar to those described above, the compressed modulation matrices for a number of levels L different from 3 can be obtained. The mathematical demonstration is omitted for the sake of brevity. In the case of a four-level inverter (L=4), the modulation matrices in compressed form are shown in Table 6 below:

TABLE 6

| Vector no. (X) | matrix R_{X}_{_{—}}_{M} (1) | matrix R_{X}_{_{—}}_{M} (2) |
|---|---|---|
| 0 | [42641 657 1] | [41985 42641 1] |
| 1 | [61363 1971 1043] | [60435 61363 1043] |
| 2 | [65527 12279 11447] | [64695 65527 11447] |

The matrices can be stored in 288 bits (36 bytes) of memory with the conventional
notation

$${Y}_{0 \_ M} = [ \begin{matrix}{R}_{0 \_ M} ( 2 ) \\ {R}_{0 \_ M} ( 1 )\end{matrix} ] \\ {Y}_{1 \_ M} = [ \begin{matrix}{R}_{1 \_ M} ( 2 ) \\ {R}_{1 \_ M} ( 1 )\end{matrix} ] \\ {Y}_{2 \_ M} = [ \begin{matrix}{R}_{2 \_ M} ( 2 ) \\ {R}_{2 \_ M} ( 1 )\end{matrix} ] \qquad ( 36 )$$

In the case of a five-level inverter (L=5), the following is obtained:

TABLE 7

| Vector | | |
|---|---|---|
| no. (X) | matrix R_{X}_{_{—}}_{M} (1) | matrix R_{X}_{_{—}}_{M} (2) |
| 0 | [21549601 21025 1] | [21528577 21549601 1] |
| 1 | [31061603 63075 32803] | [31031331 31061603 32803] |
| 2 | [33292007 655079 623207] | [33260135 33292007 623207] |
| 3 | [33554415 6029295 6002415] | [33527535 33554415 6002415] |

$${Y}_{0 \_ M} = [ \begin{matrix}{R}_{0 \_ M} ( 2 ) \\ {R}_{0 \_ M} ( 1 )\end{matrix} ] \\ {Y}_{1 \_ M} = [ \begin{matrix}{R}_{1 \_ M} ( 2 ) \\ {R}_{1 \_ M} ( 1 )\end{matrix} ] \\ {Y}_{2 \_ M} = [ \begin{matrix}{R}_{2 \_ M} ( 2 ) \\ {R}_{2 \_ M} ( 1 )\end{matrix} ] \\ {Y}_{3 \_ M} = [ \begin{matrix}{R}_{3 \_ M} ( 2 ) \\ {R}_{3 \_ M} ( 1 )\end{matrix} ] \qquad ( 37 )$$

Application of the New SVM Method to a Three-Phase, L-Level Inverter Having defined the duty cycle vector and the modulation matrices as well as the compressed modulation matrices as illustrated above, the way the control algorithm of the driving of the inverter operates will now be clarified. This algorithm can advantageously be implemented on processors in which the following elementary instructions are available:
AND=bit by bit “AND” instruction
ADD/MPY/SHIFT/MAC=arithmetical addition, multiplication, translation and multiplication-accumulation
ROT=clockwise binary rotation

The steps of the method can be summarized as follows:

The first step consists of expressing in polar coordinates the rotating vector V₀ that represents the three-phase voltage of the inverter.

Substantially, having to drive the three-phase inverter in such a way as to obtain a three-phase voltage output represented by a set of three balanced rotating voltages, first of all these voltages are represented as a single rotating vector V₀ in the complex plane. The rotating vector V₀ is defined by:

$${V}_{0} = M {e}^{j α} in which \text{:} \\ 0 \leq M = \frac{2}{\sqrt{3}} \frac{{V}_{0}}{Vb} \leq 1 \; 0 \leq α \leq 2 π \qquad ( 38 )$$

where M is the modulation index associated to the rotating vector V₀. The angle α is the electric angle between the rotating vector and the real axis of the complex plane,j is the imaginary unit.

At each PWM cycle, it is necessary to determine the sector of the complex plane in which the rotating vector V₀ is instantaneously located and the value of the modified phase angle, hereafter indicated as α̅

For this purpose, various methods can be used. In advantageous embodiments of the invention, the phase angle α is divided by the dimension of a sector. Since the complex plane is divided into six sectors, each sector will have an amplitude of 60°, i.e. π/3 radiants. To determine in which sector the rotating vector V₀ representative of the voltage to be obtained at the output of the three-phase inverter is instantaneously located, it is sufficient to divide the value of the phase angle α by π/3 and to compare the value obtained with the six values indicated in the left column of the following Table 8:

TABLE 8

| α_sector | Number of the sector (P) |
|---|---|
| π/3 | 1 |
| 2π/3 | 2 |
| π | 3 |
| 4π/3 | 4 |
| 5π/3 | 5 |
| 2π | 6 |

The sector in which the rotating vector is located is given by the row corresponding to the first value of α_sector for which

α<α_sector (39)

For example, if the angle is 30° (π/6), then the sector P in which the vector V₀ is located is the sector P=1, since (π/6)<π/3.

Having identified the number P of the sector in which the rotating vector V₀ is located instantaneously, the modified phase angle α̅ to be considered in the subsequent calculation of the duty cycle vector (vector D) is defined as:

$$\overline{α} = α - \frac{π}{3} ( P - 1 ) \qquad ( 40 )$$

Essentially, the modified phase angle is obtained by offsetting the phase of the vector until this vector, and the entire sector in which it lies, is brought back to a geometric condition similar to the one of the first sector. Based on the modified phase angle, the three values of the duty cycle are calculated as

$${δ}_{1} = \frac{M}{2 * ( L - 1 )} * ( \sqrt{3} cos \overline{α} - sin \overline{α} ) \\ {δ}_{2} = \frac{M}{L - 1} * sin \overline{α} \\ {δ}_{3} = \frac{1}{L} ( 1 - \frac{M}{2 * ( L - 1 )} ( \sqrt{3} cos \overline{α} + sin \overline{α} ) ) \qquad ( 41 )$$

where L is the number of levels of the inverter. In the case of three-level inverters (L=3), the three values of the duty cycle are those obtained in the expressions in the formulas (21), i.e.

$${δ}_{1} = \frac{M}{4} * ( \sqrt{3} cos \overline{α} - sin \overline{α} ) \\ {δ}_{2} = \frac{M}{2} * sin \overline{α} \\ {δ}_{3} = \frac{1}{3} - \frac{M}{6} ( \sqrt{3} cos α + sin α ) \qquad ( 42 )$$

The duty cycle vector D is hence given by:

$$D [ \begin{matrix}\underbrace{\begin{matrix}{δ}_{1} & {δ}_{1} & … & {δ}_{1}\end{matrix}}_{L \frac{L - 1}{2} elements} & \underbrace{\begin{matrix}{δ}_{2} & {δ}_{2} & … & {δ}_{2}\end{matrix}}_{L \frac{L - 1}{2} elements} & \underbrace{\begin{matrix}{δ}_{3} & {δ}_{3} & … & {δ}_{3}\end{matrix}}_{L elements}\end{matrix} ] \qquad ( 43 )$$

which in the case of three-level inverters (L=3) leads to:

D=[δ₁δ₁δ₁δ₂δ₂δ₂δ₂δ₃δ₃δ₃] (44)

Since, as seen above, the variables for the driving of the switches of the inverter are obtained by the matrix multiplication of the duty cycle vector by the corresponding modulation matrices of the relevant sector, in turn obtained by an inverse operation with respect to the operation whereby the compressed modulation matrices were obtained, the next step of the driving algorithm consists of the selection of the compressed modulation matrices corresponding to the sector in which the rotating vector is located and subsequently of the expansion of the compressed modulation matrices to obtain the modulation matrices that, multiplied by the duty cycle vector D, yield the driving variables.

The compressed modulation matrices are L−1 matrices from R₀_{_{—}}_{M} to R_{L-2}_{_{—}}_{M} collected in (L−1) groups Y₀_{_{—}}_{M} to Y_{L-2}_{_{—}}_{M}. As seen in the previous discussion, in the case of three-level inverters (L=3), the compressed matrices are obtained from (see formula 35):

$${Y}_{0 \_ M} = [ \begin{matrix}{R}_{0 \_ M} ( 2 ) \\ {R}_{0 \_ M} ( 1 )\end{matrix} ]$$

$${Y}_{1 \_ M} = [ \begin{matrix}{R}_{1 \_ M} ( 2 ) \\ {R}_{1 \_ M} ( 1 )\end{matrix} ]$$

In the case of four and five-level inverters, the matrices are obtained from the formulas (36) and (37):

$${Y}_{0 \_ M} = [ \begin{matrix}{R}_{0 \_ M} ( 2 ) \\ {R}_{0 \_ M} ( 1 )\end{matrix} ] {Y}_{1 \_ M} = [ \begin{matrix}{R}_{1 \_ M} ( 2 ) \\ {R}_{1 \_ M} ( 1 )\end{matrix} ] {Y}_{2 \_ M} = [ \begin{matrix}{R}_{2 \_ M} ( 2 ) \\ {R}_{2 \_ M} ( 1 )\end{matrix} ]$$

$$and$$

$${Y}_{0 \_ M} = [ \begin{matrix}{R}_{0 \_ M} ( 2 ) \\ {R}_{0 \_ M} ( 1 )\end{matrix} ] {Y}_{1 \_ M} = [ \begin{matrix}{R}_{1 \_ M} ( 2 ) \\ {R}_{1 \_ M} ( 1 )\end{matrix} ] {Y}_{2 \_ M} = [ \begin{matrix}{R}_{2 \_ M} ( 2 ) \\ {R}_{2 \_ M} ( 1 )\end{matrix} ] {Y}_{3 \_ M} = [ \begin{matrix}{R}_{3 \_ M} ( 2 ) \\ {R}_{3 \_ M} ( 1 )\end{matrix} ]$$

and the numeric values are indicated respectively in the Tables 7 and 8.

Through the application of the rotation, for each branch of the inverter the modulation matrices are obtained, which need to be multiplied by the duty cycle vector. The operations that convert the compressed modulation matrices in the non-compressed modulation matrices are the following:

$$\begin{matrix}\begin{matrix}\begin{matrix}{R}_{0 \_ M} = ROT \{ \begin{matrix}{Y}_{0 \_ M} [ P - ( P >> 1 ) << 1 ] , \\ P - 1 + ( P >> 1 ) + ( P >> 1 ) << 1\end{matrix} \} \\ …\end{matrix} \\ …\end{matrix} \\ {R}_{L - 2 \_ M} = ROT \{ \begin{matrix}{Y}_{L - 2 \_ M} [ P - ( P >> 1 ) << 1 ] , \\ P - 1 + ( P >> 1 ) + ( P >> 1 ) << 1\end{matrix} \}\end{matrix} \qquad ( 45 )$$

In the above equations, P indicates the sector in which the rotating vector V₀ is located according to Table 8, and according to a conventional notation the symbol “<<” indicates a rotation (shift) by one bit to the right, whilst the symbol “>>” indicates a rotation (shift) by one bit to the left.

The operations required to obtain the indices of the expanded modulation matrices are then simple rightwards or leftwards shift and addition or subtraction operations. All these operations are native in microprocessors and in DSPs and hence the entire process of retrieval of the modulation matrices can be executed in very short calculation times. This enables to drive even inverters with many levels, storing a limited number of data, retrieving the modulation matrices from the stored data with calculations that can be carried out in very short times.

Once the modulation matrices are obtained from the compressed modulation matrices, the values of the duty cycles are obtained executing the row by column product in binary form between the duty cycle vector and the modulation matrices in binary form. This multiplication operation is expressed as

$$\begin{matrix}\begin{matrix}\begin{matrix}\begin{matrix}{δ}_{{S}_{0}} = D ⊗ {R}_{0 \_ M} \\ {δ}_{{S}_{1}} = D ⊗ {R}_{1 \_ M}\end{matrix} \\ …\end{matrix} \\ …\end{matrix} \\ {δ}_{{S}_{L - 2}} = D ⊗ {R}_{L - 2 \_ M}\end{matrix} \qquad ( 46 )$$

Since L is the number of levels of the inverter, the vector D is a vector with 1×L² dimensions, whilst the modulation matrices are substantially constituted by vectors with dimension 1×3, where each element is in turn constituted by a column of L² binary digits (1,0). For example, in the case of three-level inverters (L=3) it has been seen that the modulation matrices are those shown in Table 3.

The matrix multiplication between a vector K, comprising one row of L² elements, and a matrix J, comprising 3×L² elements, defined as follows:

K=(K₁K₂K₃ . . . K_{L}_{²}) where: KₓεR⁺

J=(J₁J₂J₃) where: Jₓ=Jₓ_{_{—}}₁Jₓ_{_{—}}₂Jₓ_{_{—}}₃ . . . Jₓ_{_{—}}_{L}_{²} (47)

is defined by

W=(W₁W₂W₃)=K [symbol] J (48)

where each element W_{z} is given by

$${W}_{z} = {{MAC}_{i = 1}}^{{L}^{2}} ( {K}_{i} * {J}_{z \_ i} ) \qquad ( 49 )$$

in which the operator MAC is represented by the “multiply and accumulate” operator, which constitutes one of the elementary instructions of the microprocessor or of the DSP on which the inverter driving algorithm is run.

Therefore, the driving signals of the switches of the various levels in the individual branches of the inverter are obtained with a matrix multiplication of the duty cycle vector D and of the modulation matrices, with minimal calculation times, given the native nature of the instruction used.

The quantities

(δ_{S}_{₀},δ_{S}_{₁}, . . . ,δ_{S}_{_{L-2}}) (50)

obtained from the aforesaid multiplication represent the duty cycle variables for the switches of the upper part of each branch of the inverter, i.e. in the case of three-level inverters (FIG. 1B), the switches HH and HL, where expression (49) is reduced to

(δ_{S}_{₀},δ_{S}_{₁}) (51)

The values thus calculated are loaded as duty cycle variables in a modulator of a microcontroller that drives the inverter. The output of the modulator, on the basis of the duty cycles thus calculated, constitutes the on/off driving signal of the switches of the upper part and, through a negation operation, the driving signals of the corresponding switches in the lower part are obtained.

FIG. 6 shows a diagram of a possible application of the modulation method for driving a three-phase inverter for the conditioning of the electric energy generated by a DC source. In some embodiments, the DC source can be a renewable source. In some embodiments, the DC source can be a photovoltaic panel or a field of photovoltaic panels. In the diagram of FIG. 6, the DC source is schematically indicated with 101. It is connected to the input of a generic inverter 103, which can be for example a three-phase inverter with two or three levels, or even with a higher number of levels.

The output of the inverter can be connected to a load, or to an electric grid. In the example illustrated in FIG. 6, the reference number 105 schematically indicates a three-phase electric distribution grid. Typically, in some embodiments it is necessary to control the inverter 103 in such a way that it injects a determined power on the electric grid 105. The reference W (power) indicates a power feedback signal. The control and drive system (generically indicated with the reference 107) of the inverter 103 comprises a controller 107A which, on the basis of the signal W, calculates the modulation index M and the electric angle α of the rotating vector V₀ that represents the three-phase voltage that is required at the output from the inverter 103 to supply on the grid 105 the required power, defined by the signal W. From the values of the modulation index and of the electric angle, the control and drive system calculates the duty cycle vector. Through the multiplication of the duty cycle vector and the modulation matrices, stored in the control system 107, the duty cycles are calculated which, supplied to the PWM modular, enable to generate the physical signals for driving the electronic switches of the inverter.

In the embodiments of the invention described above, reference is made to a voltage controlled inverter. On the basis of the same concept described above, a method for modulating a current controlled inverter can be implemented.

### Capacitor Balancing—General Disclosure

As noted in the introductory part of the specification, in a non-ideal inverter the bulk capacitors arranged across the input terminals of the inverter can become unbalanced, i.e. the voltage across one capacitor can increase or decrease with respect to the voltage across the other capacitors.

Here below a novel method is disclosed, which can be used in combination with a SVM method as the one disclosed here above, and having the purpose of reducing or suppressing capacitor unbalancing phenomena without the need of additional electronic components.

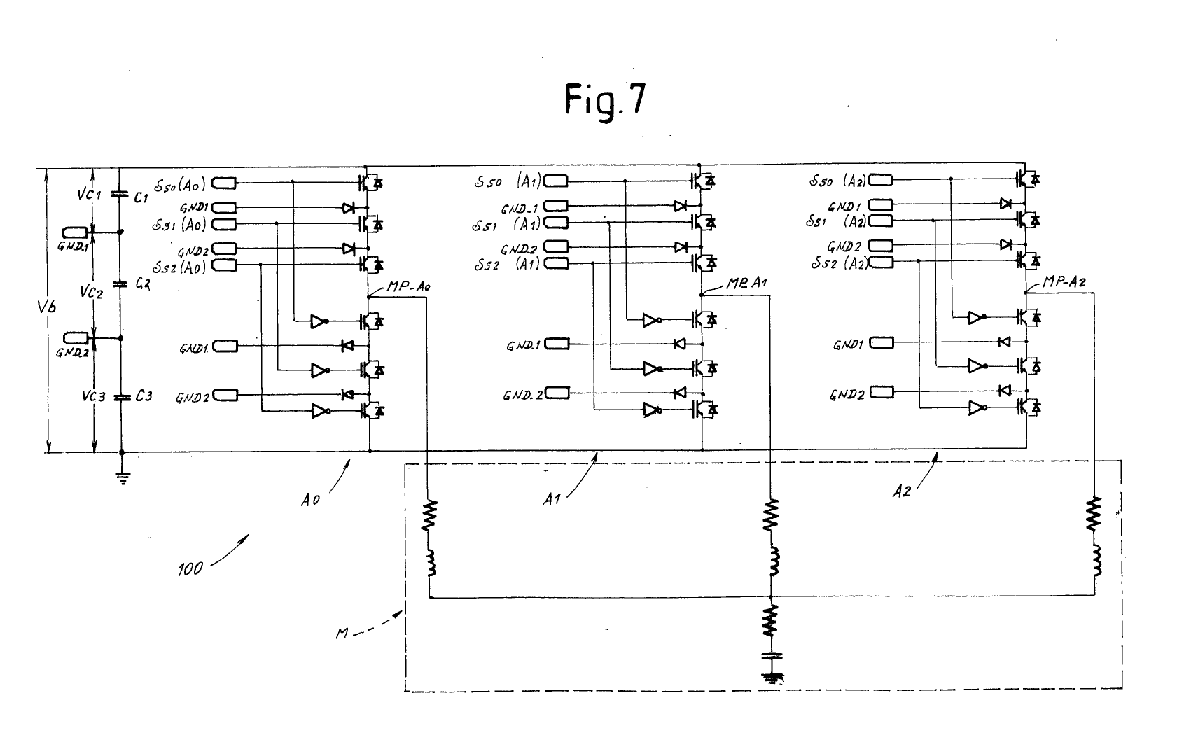

Reference will be made here below to an exemplary embodiment of the balancing method applied to a three-phase, four-level inverter such as the one shown in FIG. 7 and labeled 100 as a whole. The structure of the inverter 100 of FIG. 7 is similar to the structure of inverter 1 in FIG. 1B. However, since inverter 100 is a four-level inverter, it includes a larger number of switches, namely six switches per leg or branch (A0, A1, A2) and a larger number of bulk capacitors, namely three (L−1) capacitors across the input terminals. The capacitors are labeled C1, C2, C3 in FIG. 7.

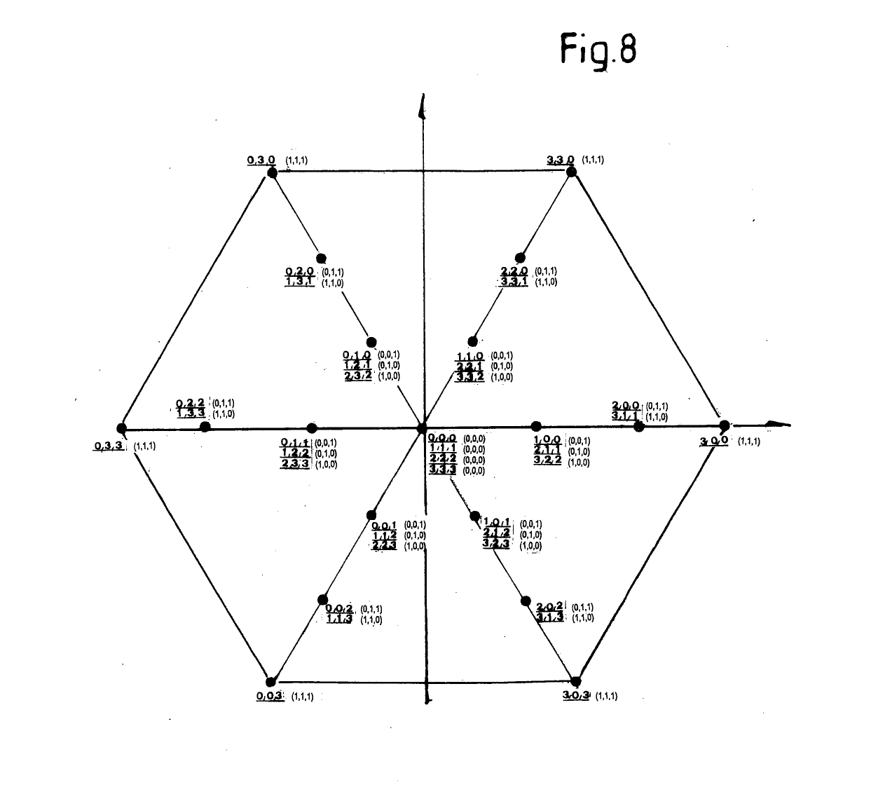

Following the SVM theory disclosed above, in a preferred embodiment of the invention the state vectors useful for the modulation of inverter 100 can be those represented in the complex plane of the state vectors shown in FIG. 8, which is a sub-set of the complete set of state vectors, obtained as disclosed above. In the diagram of FIG. 8 six axes departing from the center point are represented. These axes divide the complex plane into six sectors each spanning over 60 electric degrees. On each axis the state vectors are represented in the form of state triplets. More specifically in the present case 40 state vectors are taken into consideration, each defined by a respective state triplet. The state triplets are indicated by three digits in bold character underlined in the diagram of FIG. 8.

In the diagram of FIG. 8, for each state triplet a further triplet is indicated, which will here below designated as “power triplets”. These power triplets indicate the differential power fluxes through the bulk capacitors for each state of the inverter represented by the corresponding state triplet. Each power triplet is defined by a set of three digits, shown in brackets in FIG. 8. In each triplet the first digit refers to the power flux in capacitor C1, the second digit refers to the power flux in capacitor C2 and the third digit refers to the power flux in capacitor C3 (see FIG. 7). Each digit can be either “0” or “1”. Digit “0” means that no power (current) flows through the capacitor. Digit “1” means that power (current) flows through the capacitor.

It is noted that while the state triplets in the diagram in FIG. 8 are different for the six axes depicted in the figure, the power triplets are identical for the six axes.

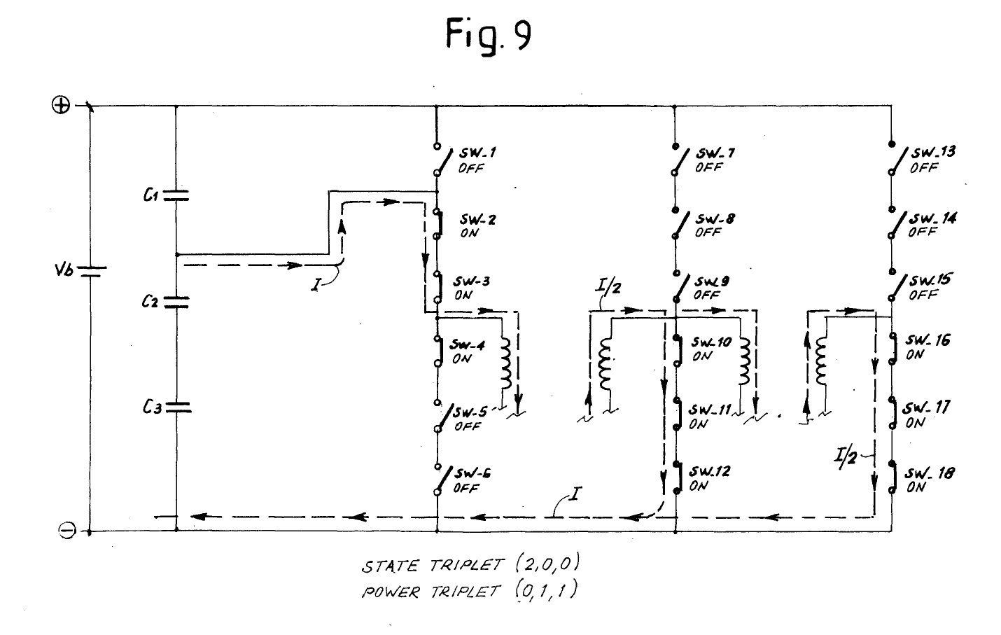

By way of example, FIG. 9 represents a simplified diagram of the inverter in the state represented by the state triplet (2,0,0). For each one of the 18 switches the state (ON or OFF) is indicated. Each switch is labeled for the sake of simplicity as SW_{—}1 . . . SW_{—}18 in sequence. The switches SW_{—}1 and SW_{—}4 in the first leg or branch A0 are ON; the switches SW_{—}10, SW_{—}11, SW_{—}12 in the low voltage section of the second branch A1 are ON and the switches SW 16, SW_{—}17 and SW 18 in the low voltage section of branch A2 are ON. All remaining switches are OFF. Current I flows through capacitor C2 and exits the inverter at mid point MP_A0. Currents I/2 enter the inverter through mid points MP_A1 and MP_A2 and flow through capacitor C3. Since power is flowing through capacitor C2 and C3 but no power is flowing through capacitors C1, the power triplet is (0,1,1).

With similar considerations, all the state triplets can be associate with a power triplet thus obtaining the triplet sets of FIG. 7.

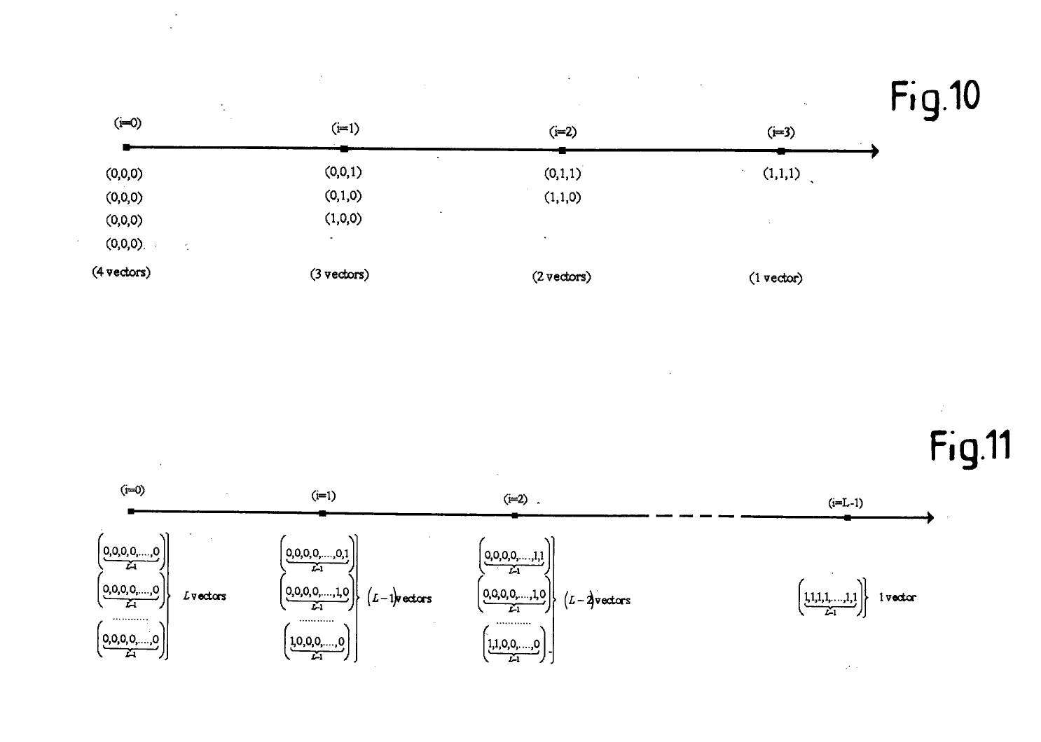

As noted above, the same power triplet pattern is present on each of the six axes departing from the center of the diagram in FIG. 7. It suffices therefore to consider one of said axes only. FIG. 10 represents the power triplet pattern for one axis in the case of the three-phase, four-level inverter of FIG. 8.

In an L-level inverter there are L−1 capacitors C1, C2, C3, . . . C(L−1) so that for each vector state a “power (L−1)-plet” is defined. The pattern of said power (L−1)plets is shown in FIG. 11, with 0≦i≦L−1.

For each i-th point along the axis a matrix of (L−i) rows and (L−1) columns can be defined. This (L−i)×(L−1) matrix, also defined “balancing matrix”, is formed by all the power (L−1)-plets corresponding to the inverter state represented by the i-th point considered. For example, for a 12-level inverter the matrix corresponding to the 5th point (i=4) along the generic axis of the state vector diagram is the following

$$M ( i ) = [ \begin{matrix}0 & 0 & 0 & 0 & 0 & 0 & 0 & 1 & 1 & 1 & 1 \\ 0 & 0 & 0 & 0 & 0 & 0 & 1 & 1 & 1 & 1 & 0 \\ 0 & 0 & 0 & 0 & 0 & 1 & 1 & 1 & 1 & 0 & 0 \\ 0 & 0 & 0 & 0 & 1 & 1 & 1 & 1 & 0 & 0 & 0 \\ 0 & 0 & 0 & 0 & 1 & 1 & 1 & 1 & 0 & 0 & 0 \\ 0 & 0 & 0 & 1 & 1 & 1 & 1 & 0 & 0 & 0 & 0 \\ 0 & 0 & 0 & 1 & 1 & 1 & 1 & 0 & 0 & 0 & 0 \\ 0 & 0 & 1 & 1 & 1 & 1 & 0 & 0 & 0 & 0 & 0 \\ 0 & 1 & 1 & 1 & 1 & 0 & 0 & 0 & 0 & 0 & 0 \\ 1 & 1 & 1 & 1 & 0 & 0 & 0 & 0 & 0 & 0 & 0\end{matrix} ] ( L - i ) \times ( L - 1 ) \qquad ( 52 )$$

It is important to notice that the M(i) matrix is a multi-diagonal inverse matrix, where the depth of the diagonal containing the digit “1” is exactly the i-th order, i.e. it corresponds to the position along the extension of the axis.

Having noticed the above and having defined the power (L−1)-plets for a generic L-level inverter, the capacitor balancing method will now be described, reference being initially made to a four-level inverter (L=4) by way of example (FIG. 10).

If Vb is the voltage differential across the positive and negative input terminals of the inverter, in a balanced situation the voltage across each capacitor should be

Vc₁=Vc₂=Vc₃=Vb/3 (53)

where Vc₁, Vc₂ and Vc₃ are the voltages across capacitors C1, C2 and C3 (FIG. 7).

Let's now consider a situation where the capacitor balance is lost, for example,

$${Vc}_{1} > \frac{Vb}{3} .$$

This means that capacitor C1 is overcharged. It is therefore necessary to partially discharge the capacitor C1 to re-establish the balance. This can be done e.g. using the state vector (3,2,2), which corresponds to a power triplet (1,0,0). This means that in such state power flows through the capacitor C1 while no power flows through capacitors C2 and C3. Therefore, re-balancing is achieved by discharging capacitor C1 and leaving capacitors C2 and C3 unchanged, until a balanced situation is achieved again.

The above criterion can be applied also to “series of capacitors”. For example, if

$${Vc}_{2} + {Vc}_{3} > \frac{2}{3} Vb \qquad ( 54 )$$

this means that the series of capacitors C2 and C3 is overcharged. They can be discharged using the inverter state (2,0,0) for example, whose power triplet is (0,1,1), i.e. in the inverter state (2,0,0) power flows through capacitors C2 and C3 but not through capacitor C1. In this way, C2 and C3 are discharged and C1 remains unchanged, until a balanced situation is reached again.

A way of performing balancing is to apply to the state vector (2,0,0), which has been chosen for balancing the capacitors, a scaling factor. Applying a scaling factor means that when the rotating voltage vector V₀ is synthesized using the state vector (2,0,0) the duty cycle vector is modified to alter the application time of the selected state vector with respect to the theoretical time calculated based e.g. on the above described SVM algorithm.

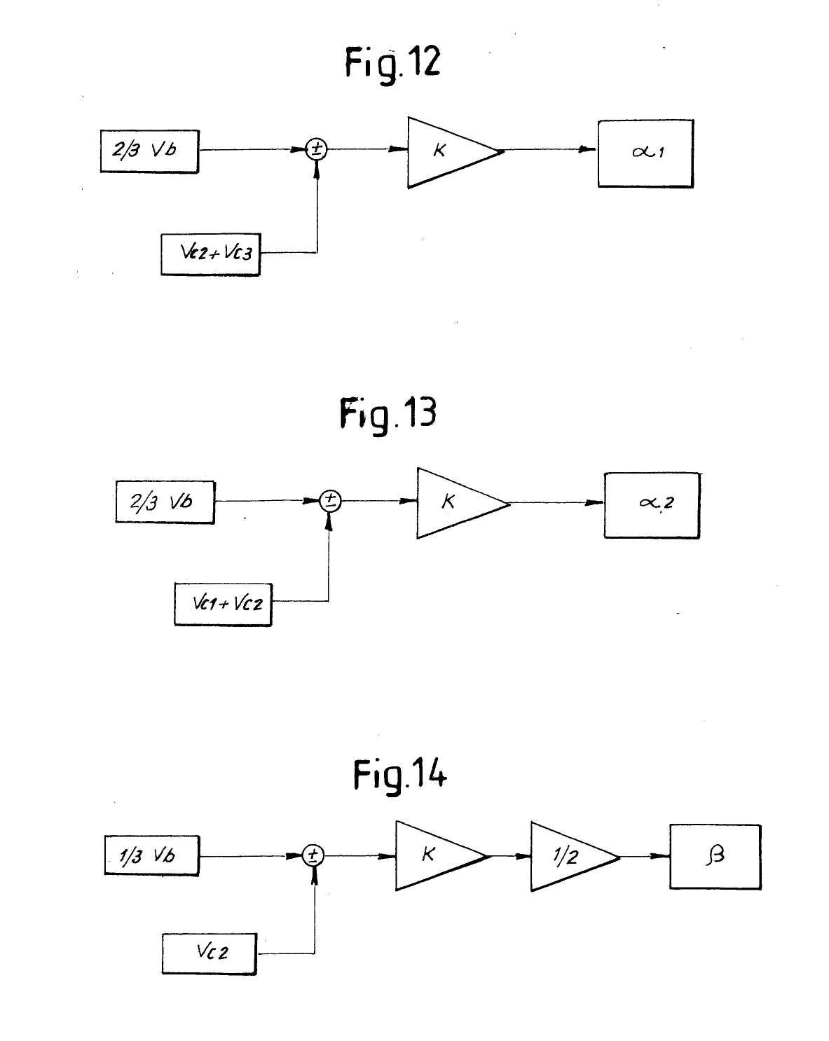

This scaling factor is 1+α₁, where α₁ is calculated as diagrammatically shown in FIG. 12 in the case where balancing of the C2, C3 capacitors in series is required. The value of the voltage across the C2, C3 series of capacitors is compared with the theoretical voltage value (⅔Vb) and the difference, representing the error or unbalancing, is applied to a simple proportional regulator whose gain is indicated as K. Therefore

$${α}_{1} = K ( \frac{2}{3} Vb - {Vb}_{2} - {Vc}_{3} ) \qquad ( 55 )$$

As can be seen in the diagram of FIG. 8, and as described with respect to the SVM method disclosed above, the (2,0,0) state vector is not the only one associated to the effective space vector point considered. There is also the state vector (3,1,1). As discussed above, in one embodiment of the SVM method, both state vectors are used in a linear combination to synthesize the rotating vector V₀ representing the output voltage. If the series of capacitors C1, C2 are unbalanced, the (3,1,1) state vector can be used to rebalance the C1, C2 series of capacitors, since the power triplet (1,1,0) is associated to the state vector or state triplet (3,1,1). This can be done applying a scaling factor of 1+α₂, where α₂ is calculated as diagrammatically shown in FIG. 13, in the same way as disclosed for the term α₁ used to calculate the scaling factor to be applied to the first state vector (2,0,0)

$${α}_{2} = K ( \frac{2}{3} Vb - {Vb}_{1} - {Vc}_{2} ) \qquad ( 56 )$$

As will be discussed later on, both αⱼ terms include a constant factor and a summation factor. The first one is determined by the total bulk voltage Vb, the number of levels of the inverter and the position (i) of the point considered along the axis of the state vector diagram.

The value of the voltage across the C1, C2 series of capacitors is compared with the theoretical voltage value (⅔Vb) and the difference, representing the error or unbalancing, is applied to the simple proportional regulator whose gain is indicated as K.

Thus, when the state vectors (2,0,0) and (3,1,1) are used in combination to synthesize the rotating voltage vector V₀ representing the inverter output voltage, two scaling factors 1+α₁ and 1+α₂ can be applied to the two state vectors in order to re-balance the capacitors, if required.

It should now be noted that if α₁ and α₂ are different from zero, i.e. if balancing is required, the sum of these factors can be different from zero. This means that the total application time for the state vectors (2,0,0) and (3,1,1) will exceed the one programmed with the pre-calculated duty cycle based on the SVM algorithm disclosed above. This would cause an output voltage distortion.

To prevent this event and thus to obtain realize a Voltage Source-invariant inverter, according to a preferred embodiment of the method disclosed herein, the two scale factors can be corrected by adding an identical correction factor (3 to both of said scale factors. The correction factor (3 is selected such that the sum of the scaling factors corrected by the added correction factor is 2. Mathematically the following condition shall be satisfied:

(1−β+α₁)+(1−β+α₂)=2 (57)

and therefore:

$$β = \frac{{α}_{1} + {α}_{2}}{2} \qquad ( 58 )$$

Considering that Vb is the sum of the voltages across all the bulk capacitors in series at the inverter input, and further considering the definition of the scale factors, the sum of α₁ and α₂ can be expressed as follows (note that the K factor is placed here as “1” and will be reintroduced after using the linearity property of the definitions):

$$\begin{matrix}{α}_{1} + {α}_{2} = \frac{2}{3} Vb - {Vc}_{2} - {Vc}_{3} + \frac{2}{3} Vb - {Vc}_{1} - {Vc}_{2} \\ = \frac{4}{3} Vb - ( {Vc}_{1} + {Vc}_{2} + {Vc}_{3} ) - {Vc}_{2} = \frac{Vb}{3} - {Vc}_{2}\end{matrix} \qquad ( 59 )$$

and therefore:

$$β = \frac{1}{2} ( \frac{Vb}{3} - {Vc}_{2} ) \qquad ( 60 )$$

FIG. 14 shows how the β factor is calculated. As can be seen, the correction factor is calculated based on a term which is a function of the number of levels L of the inverter, the position of the point (i) considered along the axis of the state vector diagram and the bulk voltage across the input terminals of the inverter.

Summarizing, the following duty correction pattern for the two state vectors (2,0,0) and (3,1,1) considered is needed:

(2,0,0)→(1−β)+α

(3,1,1)→(1−β)+α₂ (61)

This leads to selective capacitor series balancing and VSI-invariance of the balancing operation.

The corrective factor β is equal to zero in case of single balancing action, which is associated to the power triplet of index “i=1” in FIGS. 10 and 11, i.e. where power flows through a single capacitor and therefore only a single capacitor can be re-balanced.

The previous principle can be extended to an L-level inverter, for which power (L−1)-plets can be defined, each comprising (L−1) digits (1; 0). As stated above, the digits 1 and 0 indicate the following status of each capacitor:

power flowing through=1

no power flowing through=0

Let's first consider a 6-level inverter (L=6) and i=3, i.e. the fourth point along the axis of FIG. 12. The power 5-plets, i.e. the sets of five digits representing the status of the five capacitors for the i=3 state vectors are:

(0,0,1,1,1)→(1−β(3))+α₁

(0,1,1,1,0)→(1−β(3))+α₂

and the balancing matrix is

$$M ( 3 ) = [ \begin{matrix}0 & 0 & 1 & 1 & 1 \\ 0 & 1 & 1 & 1 & 0 \\ 1 & 1 & 1 & 0 & 0\end{matrix} ]$$

(1,1,1,0,0)→(1−β(3))+α₃ (62)

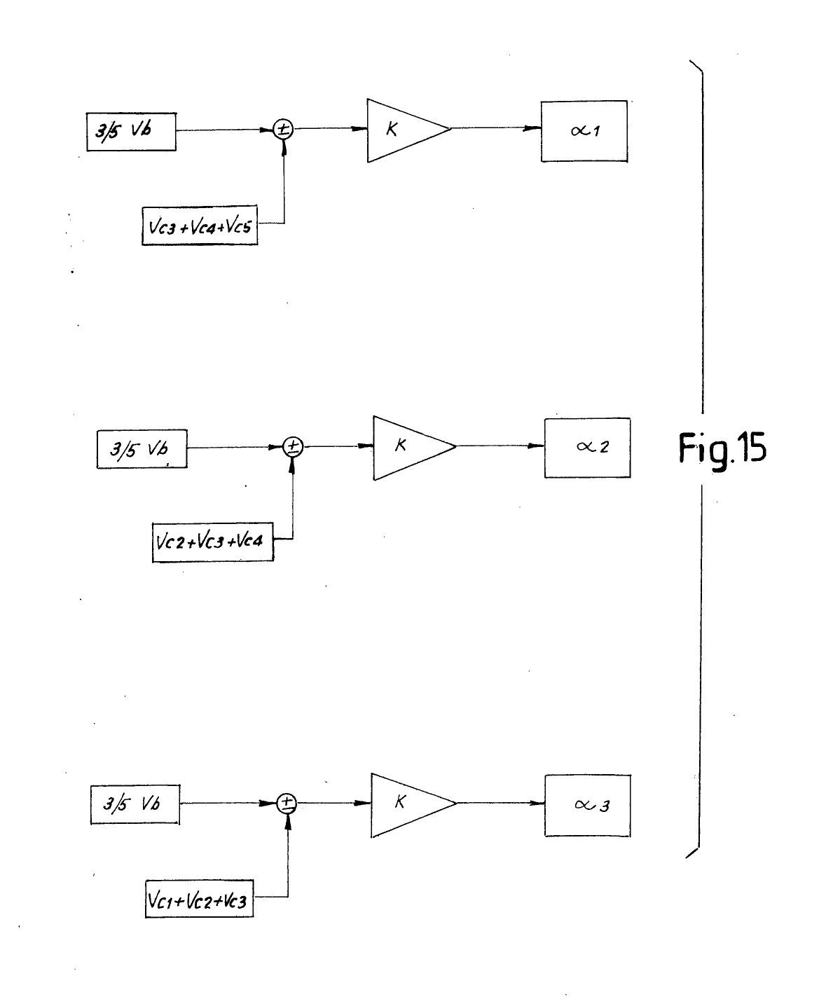

Three state vectors correspond to this fourth point along the axis of FIG. 12 and therefore three scaling factors for capacitor re-balancing are calculated. The terms α₁, α₂ and α₃ of the three scaling factors will be calculated as described above, and as schematically summed-up in FIG. 15. The corrective term will be indicated as β(3), the number (3) indicating the position of the point considered along the axis of the state vector diagram. The corrective term β(3) can be calculated as described above for the L=4 level situation. In the present example, considering that the following condition must be met:

(1−β+α)+(1−β+α₂)+(1−β+α₃)=3 (63)

and that

Vb=Vc₁+Vc₂+Vc₃+Vc₄+Vc₅ (64)

by summing the three terms α₁, α₂ and α₃ and considering the definition of each αᵢ factor, the following is equation is obtained:

$$\begin{matrix}{α}_{1} + {α}_{2} + {α}_{3} = \frac{3}{5} Vb - {Vc}_{3} - {Vc}_{4} - {Vc}_{5} + \frac{3}{5} Vb - {Vc}_{2} - \\ {Vc}_{3} - {Vc}_{4} + \frac{3}{5} Vb - {Vc}_{1} - {Vc}_{2} - {Vc}_{3} \\ = \frac{9}{5} Vb - ( {Vc}_{1} + {Vc}_{2} + {Vc}_{3} + {Vc}_{4} + {Vc}_{5} ) - \\ {Vc}_{2} - 2 {Vc}_{3} - {Vc}_{4} \\ = \frac{4}{5} Vb - ( {Vc}_{2} + 2 {Vc}_{3} + {Vc}_{4} )\end{matrix} \qquad ( 65 )$$

and therefore:

$$M ( i ) = [ \begin{matrix}0 & 0 & 0 & 0 & 0 & 0 & 0 & 1 & 1 & 1 & 1 \\ 0 & 0 & 0 & 0 & 0 & 0 & 1 & 1 & 1 & 1 & 0 \\ 0 & 0 & 0 & 0 & 0 & 1 & 1 & 1 & 1 & 0 & 0 \\ 0 & 0 & 0 & 0 & 1 & 1 & 1 & 1 & 0 & 0 & 0 \\ 0 & 0 & 0 & 0 & 1 & 1 & 1 & 1 & 0 & 0 & 0 \\ 0 & 0 & 0 & 1 & 1 & 1 & 1 & 0 & 0 & 0 & 0 \\ 0 & 0 & 0 & 1 & 1 & 1 & 1 & 0 & 0 & 0 & 0 \\ 0 & 0 & 1 & 1 & 1 & 1 & 0 & 0 & 0 & 0 & 0 \\ 0 & 1 & 1 & 1 & 1 & 0 & 0 & 0 & 0 & 0 & 0 \\ 1 & 1 & 1 & 1 & 0 & 0 & 0 & 0 & 0 & 0 & 0\end{matrix} ] \qquad ( 68 )$$

the β(3) correction factor is formed by two elements or factors, namely
a first element, here below called “summation factor” given by Vc₂+2 Vc₃+Vc₄, which is a function of the actual voltage across some of the bulk capacitors;
a constant factor 4Vb/5, which depends upon: the position (i) considered along the axis of the state vector diagram; the number of levels L of the inverter; and by the total bulk voltage across the inverter input terminals.

Based on the above exemplary computation of the αⱼ and β(i) terms for L=4 (4-level inverter) and L=6 (6-level inverter), a generalization of the computation of said terms can be obtained as described here below, for any number of voltage levels (L) and for any point along the axis in the complex plane of the state vectors (FIGS. 8, 10 and 11) in order to determine a general way of computing the scaling factor which, applied to the duty cycle vector, will result in an automatic passive capacitor-balancing to realize a VSI system.

A first step is the generalization of the calculation of the correction term 13(i).

Starting from the above defined matrix M(i) of (L−i)×(L−1) dimension which is formed by the “1” and “0” digits representing the presence or absence of power flux in each capacitor for each point (i=0, 1, 2, . . . L−1) along a generic axis of the state vectors diagram, a cardinality vector C(i) can be defined as follows. The cardinality vector is a lx(L−1) row vector, i.e. a vector containing L−1 elements, whose generic j-th element Cⱼ is the number of “1” (ones) minus 1 (limited only to positive numbers) that are present in the j-th column of matrix M(i)

C(i)=└ONES(M(i)_{col}_{_{—}}₀)−1,ONES(M(i)_{col}_{_{—}}₁)−1, . . . ,ONES(M(i)_{col}_{_{—}}₁)−1┘ (67)

For example, for the following balancing matrix

$$M ( i ) = [ \begin{matrix}0 & 0 & 0 & 0 & 0 & 0 & 0 & 1 & 1 & 1 & 1 \\ 0 & 0 & 0 & 0 & 0 & 0 & 1 & 1 & 1 & 1 & 0 \\ 0 & 0 & 0 & 0 & 0 & 1 & 1 & 1 & 1 & 0 & 0 \\ 0 & 0 & 0 & 0 & 1 & 1 & 1 & 1 & 0 & 0 & 0 \\ 0 & 0 & 0 & 1 & 1 & 1 & 1 & 0 & 0 & 0 & 0 \\ 0 & 0 & 0 & 1 & 1 & 1 & 1 & 0 & 0 & 0 & 0 \\ 0 & 0 & 1 & 1 & 1 & 1 & 0 & 0 & 0 & 0 & 0 \\ 0 & 1 & 1 & 1 & 1 & 0 & 0 & 0 & 0 & 0 & 0 \\ 1 & 1 & 1 & 1 & 0 & 0 & 0 & 0 & 0 & 0 & 0\end{matrix} ] \qquad ( 68 )$$

the cardinality vector C(i) is:

C(i)=(0,1,2,3,3,3,3,3,3,2,1,0) (69)

Moreover, for a generic L-level inverter the theoretical bulk voltages Vc₁, Vc₂, . . . Vc_{L-1} across the L−1 capacitors can be arranged in a (L−1)×1 column vector, called “voltage vector”, as follows:

$$ψ = ( \begin{matrix}{Vc}_{1} \\ … \\ {Vc}_{L - 1}\end{matrix} ) \qquad ( 70 )$$

The summation factor of the term (3(i) is expressed as:

summation_factor=C(i)·ψ (71)

where · is the row-column product. I.e. the summation factor of the correction term in a generic point (i) along the axis of the state vector diagram is given by the row-column product of the cardinality vector C(i) and voltage vector ψ.
For the previous L=6; i=3 example:

C(3)=[0 1 2 1 0] (72)

and therefore the summation factor is

$$\begin{matrix}summation\_factor = [ \begin{matrix}0 & 1 & 2 & 1 & 0\end{matrix} ] \cdot ( \begin{matrix}{Vc}_{1} \\ {Vc}_{2} \\ {Vc}_{3} \\ {Vc}_{4} \\ {Vc}_{5}\end{matrix} ) \\ = {Vc}_{2} + 2 * {Vc}_{3} + {Vc}_{4}\end{matrix} \qquad ( 73 )$$

which corresponds to the result already obtained [see equation (66)].

The constant factor of the term β(i) depends on how many elements of the voltage vector ψ are added into the summation factor: practically, it depends on the sum of elements of the cardinality vector C(i) and is defined as

$$constant\_factor = \frac{Vb}{L - 1} {\sum }_{j = -}^{L - 1} {C ( i )}_{j} \qquad ( 74 )$$

Since for an (L−1) level inverter there are L points to be considered along a generic axis of the state vector diagram, as shown in FIG. 11, there are actually L cardinality vectors C(i) (for i=0, 1, 2, 3, . . . L−1) as well as L constant factors represented by the integers

$${\sum }_{j = 0}^{L - 1} {C ( i )}_{j} .$$

These vectors and integers can be grouped into matrices, that will be indicated as “cardinality matrix” C_{L} and “constant-factor matrix” λ_{L} and are defined as follows:

$${C}_{L} = ( \begin{matrix}C ( 0 ) \\ C ( 1 ) \\ … \\ C ( L - 1 )\end{matrix} ) L \times ( L - 1 ) \\ {λ}_{L} = [ \begin{matrix}{\sum }_{j = 0}^{L - 1} {C ( 0 )}_{j} \\ {\sum }_{j = 0}^{L - 1} {C ( 1 )}_{j} \\ … \\ {\sum }_{j = 0}^{L - 1} {C ( L - 1 )}_{j}\end{matrix} ] L \times 1 \qquad ( 75 )$$

wherein Lx(L−1) and Lx indicate the dimensions of the two matrices. The values of the terms β(i) can thus be in turn grouped in a matrix having a dimension L×1, i.e. a single column of L elements and given by the following matrix product:

$$\overline{β} = [ \begin{matrix}β ( 0 ) \\ β ( 1 ) \\ … \\ β ( L - 1 )\end{matrix} ] = K * ( {λ}_{L} * \frac{Vb}{L - 1} - {C}_{L} \cdot ψ ) \qquad ( 76 )$$

When the balancing method is executed on an operating inverter, the elements of the L×1 matrix defining the β(i) terms must be computed runtime since they depend on the total bulk voltage Vb across the input terminals of the inverter as well as on the voltage vector y. While Vb is a constant value, the elements of the voltage vector y are represented by the voltage across the L−1 capacitors. These voltage values are subject to change during operation of the inverter, resulting in capacitor unbalancing. K is the regulation constant gain already mentioned in connection to equation (56).

By way of example, the elements of the cardinality matrix C_{L} and constant-factor matrices λ_{L} for some L values are as follows:

$$\begin{matrix}L = 3 & {C}_{3} = [ \begin{matrix}0 & 0 \\ 0 & 0 \\ 0 & 0\end{matrix} ] & {λ}_{3} = [ \begin{matrix}0 \\ 0 \\ 0\end{matrix} ] \\ L = 4 & {C}_{4} = [ \begin{matrix}0 & 0 & 0 \\ 0 & 0 & 0 \\ 0 & 1 & 0 \\ 0 & 0 & 0\end{matrix} ] & {λ}_{4} = [ \begin{matrix}0 \\ 0 \\ 1 \\ 0\end{matrix} ] \\ L = 6 & {C}_{6} = [ \begin{matrix}0 & 0 & 0 & 0 & 0 \\ 0 & 0 & 0 & 0 & 0 \\ 0 & 1 & 1 & 1 & 0 \\ 0 & 1 & 2 & 1 & 0 \\ 0 & 1 & 1 & 1 & 0 \\ 0 & 0 & 0 & 0 & 0\end{matrix} ] & {λ}_{6} = [ \begin{matrix}0 \\ 0 \\ 3 \\ 4 \\ 3 \\ 0\end{matrix} ]\end{matrix} \qquad ( 77 )$$

Also the generic term αᵢ appearing in the scaling factor contains a constant element or constant factor and a summation element or summation factor. The summation factor is again a function of the actual voltage across the various bulk capacitors and therefore the terms αᵢ must be calculated runtime, based on the voltage detected across the bulk capacitors C1, C2, C3 . . . at the input side of the inverter.

A general computation criterion for both the summation factor and the constant factor of the term αᵢ is disclosed here below.

The constant factor depends on how many “1” (ones) are present in the j-th row of the balancing matrix M(i). This number is simply “i”. Therefore the constant factor is given by the following expression:

$$constant\_factor = i * \frac{Vb}{L - 1} \qquad ( 78 )$$

The balancing matrix M(i) and the voltage vector W can be used to perform the computation of the summation factor of the generic αᵢ term as follows:

summation_factor=M(i)*ψ (79)

Since for each position (i) along the axis of the state vector diagram there are (L−i) αⱼ elements (α₁, α₂, α₃, . . . α_{L-i}), the various αⱼ elements for a given position (i) can be collected in a one-column matrix as follows:

$$\overline{α} ( i ) = {[ \begin{matrix}{α}_{1} \\ {α}_{2} \\ … \\ {α}_{L - i}\end{matrix} ]}_{i} = K * ( i * \frac{Vb}{L - 1} * [ \begin{matrix}1 \\ 1 \\ … \\ 1\end{matrix} ] - M ( i ) \cdot ψ ) \qquad ( 80 )$$

wherein: 0≦i≦L−1
and where K is the regulation gain. The dimension of each matrix is (L−i)×1 and there are in total L such matrices (one for each position i=0, 1, 2, . . . L−1)

The following (L−i)×1 matrices

(1−β(i))+ α̅(i) (81)

wherein: 0≦i≦L−1
containing the scaling factor for each point along the generic axis of the state vector diagram (FIG. 11) can be properly organized in a matrix form to be used automatically into the SVM algorithm. For that purpose said matrices can be grouped to form a super-matrix expressed as follows:

$$\overline{A} = [ \begin{matrix}( 1 - β ( L - 1 ) ) + \overline{α} ( L - 1 ) \\ ( 1 - β ( L - 2 ) ) + \overline{α} ( L - 2 ) \\ ( 1 - β ( L - 3 ) ) + \overline{α} ( L - 3 ) \\ … \\ ( 1 - β ( 1 ) ) + \overline{α} ( 1 ) \\ ( 1 - β ( L - 1 ) ) + \overline{α} ( L - 1 ) \\ ( 1 - β ( L - 2 ) ) + \overline{α} ( L - 2 ) \\ ( 1 - β ( L - 3 ) ) + \overline{α} ( L - 3 ) \\ … \\ ( 1 - β ( 1 ) ) + \overline{α} ( 1 ) \\ ( 1 - β ( 0 ) ) + \overline{α} ( 0 )\end{matrix} ] \begin{matrix}\begin{matrix}\begin{matrix}\begin{matrix}\begin{matrix}\begin{matrix}\begin{matrix}\begin{matrix}\begin{matrix}\begin{matrix}( 1 \times 1 ) \\ ( 2 \times 1 )\end{matrix} \\ ( 3 \times 1 )\end{matrix} \\ …\end{matrix} \\ ( L - 1 ) \times 1\end{matrix} \\ ( 1 \times 1 )\end{matrix} \\ ( 2 \times 1 )\end{matrix} \\ ( 3 \times 1 )\end{matrix} \\ …\end{matrix} \\ ( L - 1 ) \times 1\end{matrix} \\ L \times 1\end{matrix} \qquad ( 82 )$$

here below also indicated as the “scale factors matrix”. This scale factor matrix contains a single column formed by elements, each of which is a matrix. The right most column shown in formula (82) indicates for each row, i.e. for each element of the scale factor matrix, the dimension of the sub-matrix corresponding to that row. For example the first matrix of the scale factors matrix has a dimension 1×1, i.e. it is formed by a single digit. The second matrix in the scale factors matrix has a dimension 2×1 and so on.

Thus the scale factors matrix (or super-matrix Ā) is actually formed by a column containing the (L−1) sub-matrices

(1−β(i))+ α̅(i) with 1≦i≦L−1 (83)

written twice. Each sub-matrix is a single column matrix having a variable number of elements (i.e. a dimension variable from 1 to L−1). The final element of the super-matrix is the sub-matrix

(1−β(0))+ α̅(0) (84)

which contains L elements. Therefore the super-matrix Ā has one column and a number of rows equal to:

$$2 * {\sum }_{j = 1}^{L - 1} j + L = 2 * ( \frac{L ( L - 1 )}{2} ) + L = {L}^{2} \qquad ( 85 )$$

depending upon the number L of levels of the inverter. Thus, the scale factors matrix or super-matrix Ā is a (L²×1) matrix.

It shall now be recalled that the space vector modulation method described above is based on a duty cycle vector D, which contains L² elements. See for example formula (25) for the example of a 3-level inverter (L=3) and formula (43) for the general case of an L-level inverter. The duty cycle vector D has a dimension 1×L². Balancing of the inverter capacitors using e.g. the SVM method described above is achieved by multiplying the elements of the duty cycle vector D with the elements of the matrix Ā according to an element-by-element product, to obtain a modified duty cycle vector as follows

D̅=D [symbol] Ā^{T} (86)

where [symbol] is the element-by-element product to obtain the modified duty vector D.

Using the modified duty cycle vector D̅ instead of the duty cycle vector D in the SVM algorithm described above, a passive automatic capacitor balancing will be obtained. Each element of the duty cycle vector is corrected runtime with a scale factor which is calculated based on the actual voltage across the bulk capacitors. The scale factor is calculated as to obtain re-balancing of the bulk capacitors. Referring to the above described SVM method, automatic passive balancing of the capacitors is thus achieved by simply using the elements of the modified duty cycle vector instead of the elements of the unmodified duty cycle vector D to generate the driving signals for the electronically controlled switches of the inverter.

For a more complete comprehension of the just described balancing method, the application thereof to a 3-level, three-phase inverter and to a 3-level, three phase inverter will now be described in detail.

### Example 1

### Capacitor Balancing of a 3-Level, 3-Phase Inverter

The balancing matrices are the following:

$$M ( 0 ) = [ \begin{matrix}0 & 0 \\ 0 & 0 \\ 0 & 0\end{matrix} ] \\ M ( 1 ) = [ \begin{matrix}0 & 1 \\ 1 & 0\end{matrix} ] \\ M ( 2 ) = [ \begin{matrix}1 & 1\end{matrix} ] \qquad ( 87 )$$

Moreover, the cardinality matrix, the constant-factor matrix and the voltage vector are expressed as follows:

$${C}_{3} = [ \begin{matrix}0 & 0 \\ 0 & 0 \\ 0 & 0\end{matrix} ] \\ {λ}_{3} = [ \begin{matrix}0 \\ 0 \\ 0\end{matrix} ] \\ ψ = [ \begin{matrix}{V}_{1} \\ {V}_{2}\end{matrix} ] \qquad ( 88 )$$

The β̅ vector is calculated as follows:

$$\overline{β} = [ \begin{matrix}β ( 0 ) \\ β ( 1 ) \\ β ( 2 )\end{matrix} ] = K * ( [ \begin{matrix}0 \\ 0 \\ 0\end{matrix} ] * \frac{Vb}{2} - [ \begin{matrix}0 & 0 \\ 0 & 0 \\ 0 & 0\end{matrix} ] \cdot [ \begin{matrix}{Vc}_{1} \\ {Vc}_{2}\end{matrix} ] ) = [ \begin{matrix}0 \\ 0 \\ 0\end{matrix} ] \qquad ( 89 )$$

The various αᵢ matrices are:

$$\overline{α} ( 0 ) = {[ \begin{matrix}{α}_{1} \\ {α}_{2} \\ {α}_{3}\end{matrix} ]}_{0} = K * ( 0 * \frac{Vb}{2} * [ \begin{matrix}1 \\ 1 \\ 1\end{matrix} ] - [ \begin{matrix}0 & 0 \\ 0 & 0 \\ 0 & 0\end{matrix} ] \cdot [ \begin{matrix}{Vc}_{1} \\ {Vc}_{2}\end{matrix} ] ) = [ \begin{matrix}0 \\ 0 \\ 0\end{matrix} ] \\ \overline{α} ( 1 ) = {[ \begin{matrix}{α}_{1} \\ {α}_{2}\end{matrix} ]}_{1} = K * ( 1 * \frac{Vb}{2} * [ \begin{matrix}1 \\ 1\end{matrix} ] - [ \begin{matrix}0 & 1 \\ 1 & 0\end{matrix} ] \cdot [ \begin{matrix}{Vc}_{1} \\ {Vc}_{2}\end{matrix} ] ) = K * [ \begin{matrix}\frac{Vb}{2} - {Vc}_{2} \\ \frac{Vb}{2} - {Vc}_{1}\end{matrix} ] \\ \overline{α} ( 2 ) = {[ {α}_{1} ]}_{2} = K * ( 2 * \frac{Vb}{2} * [ 1 ] - [ \begin{matrix}1 & 1\end{matrix} ] \cdot [ \begin{matrix}{Vc}_{1} \\ {Vc}_{2}\end{matrix} ] ) = K * [ Vb - ( {Vc}_{1} + {Vc}_{2} ) ] = [ 0 ] \qquad ( 90 )$$

So the scale factors matrix Ā has the following form:

$$\overline{A} = [ \begin{matrix}( 1 - β ( 2 ) ) + \overline{α} ( 2 ) \\ ( 1 - β ( 1 ) ) + \overline{α} ( 1 ) \\ ( 1 - β ( 2 ) ) + \overline{α} ( 2 ) \\ ( 1 - β ( 1 ) ) + \overline{α} ( 1 ) \\ ( 1 - β ( 0 ) ) + \overline{α} ( 0 )\end{matrix} ] = [ \begin{matrix}1 \\ 1 + K * ( \frac{Vb}{2} - {Vc}_{2} ) \\ 1 + K * ( \frac{Vb}{2} - {Vc}_{1} ) \\ 1 \\ 1 + K * ( \frac{Vb}{2} - {Vc}_{2} ) \\ 1 + K * ( \frac{Vb}{2} - {Vc}_{1} ) \\ 1 \\ 1 \\ 1\end{matrix} ] \qquad ( 91 )$$

The duty cycle vector D is:

D=[δ₁δ₁δ₁δ₂δ₂δ₂δ₃δ₃δ₃] (92)

wherein δ₁, δ₂, and δ₃ are defined by the equations (21) based on the electric angle and the modulation index M (i.e. the ratio between the amplitude of the rotating vector V₀ and the bulk voltage Vb).
The modified duty cycle vector D̅ has the following form:

$$\overline{D} = [ \begin{matrix}{δ}_{1} & {δ}_{1} & {δ}_{1} & {δ}_{2} & {δ}_{2} & {δ}_{2} & {δ}_{3} & {δ}_{3} & {δ}_{3}\end{matrix} ] ⊗ [ \begin{matrix}1 & 1 + K * ( \begin{matrix}\frac{Vb}{2} - \\ {Vc}_{2}\end{matrix} ) & 1 + K * ( \begin{matrix}\frac{Vb}{2} - \\ {Vc}_{1}\end{matrix} ) & 1 & 1 + K * ( \begin{matrix}\frac{Vb}{2} - \\ {Vc}_{2}\end{matrix} ) & 1 + K * ( \begin{matrix}\frac{Vb}{2} - \\ {Vc}_{1}\end{matrix} ) & 1 & 1 & 1\end{matrix} ] \qquad ( 93 )$$

This last equation is the key of implementation for L=3 and it is a simple element-wise multiplication of two nine locations buffers which is a basic filtering operation in a digital environment. Given the modulation index M and electric angle α required for each PWM cycle, the controller of the inverter calculates the duty cycle vector (equations 92 and 21) and, based on the values of the actual voltages across the bulk capacitors, it also calculates the modified duty cycle vector. The last is then multiplied by the modulation matrices shown in Table 3 to obtain the duty cycle signals for the various switches of the inverter.

If the inverter is balanced the voltage across the two capacitors C1 and C2 is Vc₁=Vc₂=Vb/2 and each element of the scale factors matrix Ā becomes unitary (1). Consequently the modified duty cycle vector remains identical to the duty cycle vector resulting from the SVM algorithm computation. Only if one or both voltages across the bulk capacitors differ from the theoretical Vb/2 value, will the scale factors matrix modify the duty cycle vector.

### Example 2

### Capacitor Balancing of a 4-Level, 3-Phase Inverter

In the case of 4-level inverter (L=4) the balancing matrices are as follows:

$$M ( 0 ) = [ \begin{matrix}0 & 0 & 0 \\ 0 & 0 & 0 \\ 0 & 0 & 0 \\ 0 & 0 & 0\end{matrix} ] M ( 1 ) = [ \begin{matrix}0 & 0 & 1 \\ 0 & 1 & 0 \\ 1 & 0 & 0\end{matrix} ] \\ M ( 2 ) = [ \begin{matrix}0 & 1 & 1 \\ 1 & 1 & 0\end{matrix} ] M ( 3 ) = [ \begin{matrix}1 & 1 & 1\end{matrix} ] \qquad ( 94 )$$

The cardinality matrix, the constant-factor matrix and the voltage vector are

$${C}_{4} = [ \begin{matrix}0 & 0 & 0 \\ 0 & 0 & 0 \\ 0 & 1 & 0 \\ 0 & 0 & 0\end{matrix} ] {λ}_{4} = [ \begin{matrix}0 \\ 0 \\ 1 \\ 0\end{matrix} ] ψ = [ \begin{matrix}{Vc}_{1} \\ {Vc}_{2} \\ {Vc}_{3}\end{matrix} ] \qquad ( 95 )$$

The β̅ vector is the following:

$$\overline{β} = [ \begin{matrix}β ( 0 ) \\ β ( 1 ) \\ β ( 2 ) \\ β ( 3 )\end{matrix} ] = K * ( [ \begin{matrix}0 \\ 0 \\ 1 \\ 0\end{matrix} ] * \frac{Vb}{3} - [ \begin{matrix}0 & 0 & 0 \\ 0 & 0 & 0 \\ 0 & 1 & 0 \\ 0 & 0 & 0\end{matrix} ] \cdot [ \begin{matrix}{Vc}_{1} \\ {Vc}_{2} \\ {Vc}_{3}\end{matrix} ] ) = [ \begin{matrix}0 \\ 0 \\ K * ( \frac{Vb}{3} - {V}_{2} ) \\ 0\end{matrix} ] \qquad ( 96 )$$

and the αᵢ matrices are:

$$\overline{α} ( 0 ) = {[ \begin{matrix}{α}_{1} \\ {α}_{2} \\ {α}_{3} \\ {α}_{4}\end{matrix} ]}_{0} = K * ( 0 * \frac{Vb}{3} * [ \begin{matrix}1 \\ 1 \\ 1 \\ 1\end{matrix} ] - [ \begin{matrix}0 & 0 & 0 \\ 0 & 0 & 0 \\ 0 & 0 & 0 \\ 0 & 0 & 0\end{matrix} ] \cdot [ \begin{matrix}{Vc}_{1} \\ \begin{matrix}{Vc}_{2} \\ {Vc}_{3}\end{matrix}\end{matrix} ] ) = [ \begin{matrix}0 \\ 0 \\ 0 \\ 0\end{matrix} ] \\ \overline{α} ( 1 ) = {[ \begin{matrix}{α}_{1} \\ \begin{matrix}{α}_{2} \\ {α}_{3}\end{matrix}\end{matrix} ]}_{1} = K * ( 1 * \frac{Vb}{3} * [ \begin{matrix}1 \\ \begin{matrix}1 \\ 1\end{matrix}\end{matrix} ] - [ \begin{matrix}0 & 0 & 1 \\ 0 & 1 & 0 \\ 1 & 0 & 0\end{matrix} ] \cdot [ \begin{matrix}{Vc}_{1} \\ \begin{matrix}{Vc}_{2} \\ {Vc}_{3}\end{matrix}\end{matrix} ] ) = K * [ \begin{matrix}\frac{Vb}{3} - {Vc}_{3} \\ \begin{matrix}\frac{Vb}{3} - {Vc}_{2} \\ \frac{Vb}{3} - {Vc}_{1}\end{matrix}\end{matrix} ] \\ \overline{α} ( 2 ) = {[ \begin{matrix}{α}_{1} \\ {α}_{2}\end{matrix} ]}_{2} = K * ( 2 * \frac{Vb}{3} * [ \begin{matrix}1 \\ 1\end{matrix} ] - [ \begin{matrix}0 & 1 & 1 \\ 1 & 1 & 0\end{matrix} ] \cdot [ \begin{matrix}{Vc}_{1} \\ \begin{matrix}{Vc}_{2} \\ {Vc}_{3}\end{matrix}\end{matrix} ] ) = K * [ \begin{matrix}2 * \frac{Vb}{3} - ( {Vc}_{2} + {Vc}_{3} ) \\ 2 * \frac{Vb}{3} - ( {Vc}_{1} + {Vc}_{2} )\end{matrix} ] \\ \overline{α} ( 3 ) = {[ {α}_{1} ]}_{3} = K * ( 3 * \frac{Vb}{3} * [ 1 ] - [ \begin{matrix}1 & 1 & 1\end{matrix} ] \cdot [ \begin{matrix}{Vc}_{1} \\ \begin{matrix}{Vc}_{2} \\ {Vc}_{3}\end{matrix}\end{matrix} ] ) = K * [ Vb - ( {Vc}_{1} + {Vc}_{2} + {Vc}_{3} ) ] = [ 0 ] \qquad ( 97 )$$

Therefore the super-matrix Ā has the following form:

$$\overline{A} = [ \begin{matrix}( 1 - β ( 3 ) ) + \overline{α} ( 3 ) \\ ( 1 - β ( 2 ) ) + \overline{α} ( 2 ) \\ ( 1 - β ( 1 ) ) + \overline{α} ( 1 ) \\ ( 1 - β ( 3 ) ) + \overline{α} ( 3 ) \\ ( 1 - β ( 2 ) ) + \overline{α} ( 2 ) \\ ( 1 - β ( 1 ) ) + \overline{α} ( 1 ) \\ ( 1 - β ( 0 ) ) + \overline{α} ( 0 )\end{matrix} ] = [ \begin{matrix}1 \\ 1 + K * ( Vb - ( 2 * {Vc}_{2} + {Vc}_{3} ) ) \\ 1 + K * ( Vb - ( 2 * {Vc}_{2} + {Vc}_{1} ) ) \\ 1 + K * ( \frac{Vb}{3} - {Vc}_{3} ) \\ 1 + K * ( \frac{Vb}{3} - {Vc}_{2} ) \\ 1 + K * ( \frac{Vb}{3} - {Vc}_{1} ) \\ 1 \\ 1 + K * ( Vb - ( 2 * {Vc}_{2} + {Vc}_{3} ) ) \\ 1 + K * ( Vb - ( 2 * {Vc}_{2} + {Vc}_{1} ) ) \\ 1 + K * ( \frac{Vb}{3} - {Vc}_{3} ) \\ 1 + K * ( \frac{Vb}{3} - {Vc}_{2} ) \\ 1 + K * ( \frac{Vb}{3} - {Vc}_{1} ) \\ 1 \\ 1 \\ 1 \\ 1\end{matrix} ] \qquad ( 98 )$$

The duty cycle vector D is:

D=[δ₁δ₁δ₁δ₁δ₁δ₁δ₂δ₂δ₂δ₂δ₂δ₂δ₃δ₃δ₃δ₃] (99)

and the modified duty cycle vector D has the following form:

D̅[δ₁δ₁δ₁δ₁δ₁δ₁δ₂δ₂δ₂δ₂δ₂δ₂δ₃δ₃δ₃] [symbol] Ā^{T} (100)

This last equation is the key of implementation for L=4 and it is a simple element-wise multiplication of two sixteen locations buffers which is a basic filtering operation in a digital environment.

Also in this case, from the scale factors matrix definition in (98) it is apparent that only if at least one of the voltages Vc₁, Vc₂, Vc₃ across the three bulk capacitors C1, C2, C3 of the inverter differs from the theoretical value Vb/3 will some of the elements of the scale factors matrix become different from “1” and modify the duty cycle vector when the latter two are multiplied.

While the disclosed embodiments of the subject matter described herein have been shown in the drawings and fully described above with particularity and detail in connection with several exemplary embodiments, it will be apparent to those of ordinary skill in the art that many modifications, changes, and omissions are possible without materially departing from the novel teachings, the principles and concepts set forth herein, and advantages of the subject matter recited in the appended claims.

Hence, the proper scope of the disclosed innovations should be determined only by the broadest interpretation of the appended claims so as to encompass all such modifications, changes, and omissions. In addition, the order or sequence of any process or method steps may be varied or re-sequenced according to alternative embodiments.

It should in particular be noted that the novel space vector modulation method disclosed above in connection with FIGS. 1 to 6 is particularly advantageous in terms of computational efficiency. The novel balancing method, which is one of the main aspects of the subject matter disclosed herein, has been described in detail in combination with the novel space vector modulation method. However, the features of the capacitor balancing procedure are not necessarily linked to the space vector modulation used. What is important is only that a space vector modulation method is used for controlling the PWM.

As noted in the introductory part of the above specification, space vector pulse width modulation methods of various kinds are know in the art. They are usually less efficient and computationally much heavier than the one described in detail here above, however they could be used in combination with the novel balancing method disclosed above.

As can be understood from the above description, the mathematical concept underlying the balancing method and disclosed in detail with reference to formulae (52) to (86) is entirely independent from the modulation method used. The scale factors matrix (82) has been obtained independently from the actual modulation method.

The matrix has been written in a particular form with a dimension L²×1, i.e. containing L² elements. As discussed above, most of those elements are repeated, i.e. they are not independent from one another. The reason for that is that the duty cycle vector D obtained by the space vector modulation method disclosed above contains L² elements. The particular structure of the scale factors matrix is therefore consistent with the structure of the duty cycle vector.

However, the structure of the duty cycle vector can be different if a different space vector pulse width modulation method is adopted, e.g. one of those currently known in the art. Since the elements of the scale factors matrix have been calculated independently of the modulation method, they can be used in combination with a different modulation method, provided the scale factors matrix is consistent with the duty cycle vector generated by the PWM method adopted, i.e. they shall contain the same number of elements.

For example, using a SVM method which generates a duty cycle vector containing only three elements

D=└δ₁,δ₂,δ₃┘

a scale factors matrix having the following form can be used to obtain capacitor balancing:

$$\overline{A} = [ \begin{matrix}( 1 - β ( L - 1 ) ) + \overline{α} ( L - 1 ) \\ \\ \\ ( 1 - β ( L - 1 ) ) + \overline{α} ( L - 1 ) \\ \\ ⋮ \\ ( 1 - β ( 0 ) ) + \overline{α} ( 0 )\end{matrix} ]$$

1-32. (canceled)

33. A method of pulse width modulating (PWM) a multiphase inverter comprising:
in an inverter control and drive system, calculating a duty cycle vector based on electric parameters defining a rotating vector representing an output electric quantity required from the inverter;
detecting actual voltage values across bulk capacitors provided across input terminals of the inverter; and
modifying the duty cycle vector as a function of the actual voltage values to re-balance the bulk capacitors.

34. The method of claim 33, wherein the duty cycle vector is modified by altering a conduction time of inverter switches during a PWM cycle, such as to modify the voltage across bulk capacitors, which are in an unbalanced condition, towards a balanced condition.

35. The method of claim 33, wherein:
the duty cycle vector is calculated as a function of the electric parameters defining the rotating vector;
the duty cycle vector is multiplied by a scale factors matrix, containing elements which are a function of the actual voltage values across the bulk capacitors of the inverter, to generate a modified duty cycle vector.

36. The method of claim 35, wherein the elements of the scale factors matrix are calculated based on the voltage values across the bulk capacitors and a balancing matrix, the balancing matrix containing information on a power flux through each bulk capacitor in each inverter state.

37. The method of claim 36, wherein the balancing matrix is formed by “0” and “1” digits, and wherein:
the digit is “0” for each bulk capacitor through which, in the corresponding inverter state, no power flows; and
the digit is “1” for each bulk capacitor through which, in the corresponding inverter state, power flows.

38. The method of claim 36, wherein a balancing matrix is defined for each point along an axis of a state vectors diagram, each balancing matrix having (L−i) rows and (L−1) columns, wherein:
L is the number of levels of the inverter; and
0<i<L−1 is the position of the point along the axis.

39. The method of claim 34, wherein the modified duty cycle vector is multiplied by at least one stored modulation matrix to obtain a plurality of modified duty cycle signals for driving a plurality of electronic switches of the inverter.

40. The method of claim 34, wherein the duty cycle vector is defined as:
$$D = [ \begin{matrix}\underbrace{\begin{matrix}{δ}_{1} & {δ}_{1} & … & {δ}_{1}\end{matrix}}_{L \frac{L - 1}{2} elements} & \underbrace{\begin{matrix}{δ}_{2} & {δ}_{2} & … & {δ}_{2}\end{matrix}}_{L \frac{L - 1}{2} elements} & \underbrace{\begin{matrix}{δ}_{3} & {δ}_{3} & … & {δ}_{3}\end{matrix}}_{L elements}\end{matrix} ]$$
$${δ}_{1} = \frac{M}{2 * ( L - 1 )} * ( \sqrt{3} cos \overline{α} - sin \overline{α} )$$
$${δ}_{2} = \frac{M}{L - 1} * sin \overline{α}$$
$${δ}_{3} = \frac{1}{L} ( 1 - \frac{M}{2 * ( L - 1 )} ( \sqrt{3} cos \overline{α} + sin \overline{α} ) )$$
in which L is the number of voltage levels of the inverter and
$$\overline{α} = α - \frac{π}{3} ( P - 1 )$$
wherein:
α is the electric angle of the rotating vector;
M is the modulation index of the rotating vector; and
P is the sector of the complex plane in which the rotating vector is located at the PWM cycle considered.

41. The method of claim 34, wherein the modified duty cycle vector is multiplied by a number of modulation matrices determined by the number of voltage levels of the inverter.

42. The method of claim 33, wherein, for each PWM cycle, the following steps are performed:
calculating a duty cycle vector containing a plurality of duty cycle values;
detecting the voltage values across the bulk capacitors;
when the capacitors are un-balanced, calculating scale factors for rebalancing the capacitors;
correcting the duty cycle values with scale factors to obtain a corrected duty cycle vector; and
applying the corrected duty cycle vector to drive switches of the inverter.

43. The method of claim 33, further comprising:
storing in a memory unit data defining a plurality of modulation matrices;
for each PWM cycle, determining a modulation index and a phase angle of the rotating vector;
determining in which sector of a complex plane the rotating vector is located;
calculating the duty cycle vector based on the phase angle and on the modulation index of the rotating vector;
detecting the actual voltage values across the bulk capacitors of the inverter;
calculating the modified duty cycle vector based on the actual voltage values;
executing a matrix multiplication between the modified duty cycle vector and at least one modulation matrix corresponding to the sector to obtain a plurality of modified duty cycles for a plurality of electronic switches of the inverter; and
loading the modified duty cycles into a PWM modulator of the inverter and generating, by means of the PWM modulator, physical signals for driving the switches on the basis of the duty cycles.

44. The method of claim 33, wherein the electric quantity is one of either an output voltage from the inverter or an output current from the inverter.

45. The method of claim 33, wherein the inverter is a three-phase inverter.

46. The method of claim 33, wherein the inverter is a multi-level inverter.

47. The method of claim 33, wherein for each sector into which the complex plane is subdivided, data are stored for the determination of a number of modulation matrices that depends on the number of levels of the inverter, and wherein each modulation matrix comprises a number of rows equal to a number of state vectors lying on the edges of each sector into which the complex plane is subdivided and a number of columns equal to the number of branches of the inverter.

48. The method of claim 47, wherein for each sector into which the complex plane is subdivided, data are stored for the determination of L−1 matrices, where L is the number of levels of the inverter.

49. The method of claim 48, wherein the inverter is a three-phase, two-level inverter and wherein the modulation matrices, one for each one of six 60-electric degrees sectors in which the complex plane is divided, are defined as follows:

| Sector no. | Matrix S₀_M |
|---|---|
| 1 | $[ \begin{matrix}1 & 0 & 0 \\ 1 & 1 & 0 \\ 0 & 0 & 0 \\ 1 & 1 & 1\end{matrix} ]$ |
| 2 | $[ \begin{matrix}1 & 1 & 0 \\ 0 & 1 & 0 \\ 0 & 0 & 0 \\ 1 & 1 & 1\end{matrix} ]$ |
| 3 | $[ \begin{matrix}0 & 1 & 0 \\ 0 & 1 & 1 \\ 0 & 0 & 0 \\ 1 & 1 & 1\end{matrix} ]$ |
| 4 | $[ \begin{matrix}0 & 1 & 1 \\ 0 & 0 & 1 \\ 0 & 0 & 0 \\ 1 & 1 & 1\end{matrix} ]$ |
| 5 | $[ \begin{matrix}0 & 0 & 1 \\ 1 & 0 & 1 \\ 0 & 0 & 0 \\ 1 & 1 & 1\end{matrix} ]$ |
| 6 | $[ \begin{matrix}1 & 0 & 1 \\ 1 & 0 & 0 \\ 0 & 0 & 0 \\ 1 & 1 & 1\end{matrix} ]$ |

50. The method of claim 48, wherein the inverter is a three-phase, three-level inverter and wherein the modulation matrices, one for each one of six 60-electric degrees sectors in which the complex plane is divided, are defined as follows:

| Sector no. | Matrix S₀_M |
|---|---|
| 1 | $[ \begin{matrix}1 & 0 & 0 \\ 1 & 1 & 0 \\ 0 & 0 & 0 \\ 1 & 1 & 1\end{matrix} ]$ |
| 2 | $[ \begin{matrix}1 & 1 & 0 \\ 0 & 1 & 0 \\ 0 & 0 & 0 \\ 1 & 1 & 1\end{matrix} ]$ |
| 3 | $[ \begin{matrix}0 & 1 & 0 \\ 0 & 1 & 1 \\ 0 & 0 & 0 \\ 1 & 1 & 1\end{matrix} ]$ |
| 4 | $[ \begin{matrix}0 & 1 & 1 \\ 0 & 0 & 1 \\ 0 & 0 & 0 \\ 1 & 1 & 1\end{matrix} ]$ |
| 5 | $[ \begin{matrix}0 & 0 & 1 \\ 1 & 0 & 1 \\ 0 & 0 & 0 \\ 1 & 1 & 1\end{matrix} ]$ |
| 6 | $[ \begin{matrix}1 & 0 & 1 \\ 1 & 0 & 0 \\ 0 & 0 & 0 \\ 1 & 1 & 1\end{matrix} ]$ |

51. The method of claim 33, wherein the modulation matrices are calculated by means of rotation and shift operations from a series of compressed modulation matrices.

52. The method of claim 51, wherein the inverter is a three-phase two-level inverter and wherein the compressed modulation matrices comprise:
Matrix R₀_{_{—}}_{M}
[13 5 1]
[9 13 1]
expressed in decimal notation, each decimal number in the matrices converted to binary notation defining a column of a corresponding compressed matrix in binary notation.

53. The method of claim 51, wherein the inverter is a three-phase, three-level inverter and wherein the compressed modulation matrices

| vector no. (X) | matrix Rₓ_{_{—}}_{M} (1) | matrix Rₓ_{_{—}}_{M} (2) |
|---|---|---|
| 0 | [361 41 1] | [507 123 75] |
| 1 | [321 361 1] | [459 507 75] |

expressed in decimal notation, each decimal number in the matrices converted into binary notation defining a column of a corresponding compressed matrix in binary notation.

54. The method of claim 34, wherein the inverter is a three-level, three-phase inverter, and the scale factors matrix is defined as:
$$\overline{A} = [ \begin{matrix}1 \\ 1 + K * ( \frac{Vb}{2} - {Vc}_{2} ) \\ 1 + K * ( \frac{Vb}{2} - {Vc}_{1} ) \\ 1 \\ 1 + K * ( \frac{Vb}{2} - {Vc}_{2} ) \\ 1 + K * ( \frac{Vb}{2} - {Vc}_{1} ) \\ 1 \\ 1 \\ 1\end{matrix} ]$$
and wherein
Vb is the bulk voltage across the input terminals of the inverter, VCI, VC2 are actual voltage values across the two bulk capacitors of the inverter; and
K is a gain factor.

55. The method of claim 54, wherein the duty cycle vector is defined as:
D=[δ₁δ₁δ₁δ₂δ₂δ₂δ₃δ₃δ₃]
in which
$${δ}_{1} = \frac{M}{4} ( \sqrt{3} cos \overline{α} - sin \overline{α} ) {δ}_{2} = \frac{M}{2} sin α {δ}_{3} = \frac{1}{3} - \frac{M}{6} ( \sqrt{3} cos \overline{α} + sin \overline{α} )$$
and the modified duty cycle vector is defined as:
$$\overline{D} = [ \begin{matrix}{δ}_{1} & {δ}_{1} & {δ}_{1} & {δ}_{2} & {δ}_{2} & {δ}_{2} & {δ}_{3} & {δ}_{3} & {δ}_{3}\end{matrix} ] ⊗ [ \begin{matrix}1 & 1 + K * ( \begin{matrix}\frac{Vb}{2} - \\ {Vc}_{2}\end{matrix} ) & 1 + K * ( \begin{matrix}\frac{Vb}{2} - \\ {Vc}_{1}\end{matrix} ) & 1 & 1 + K * ( \begin{matrix}\frac{Vb}{2} - \\ {Vc}_{2}\end{matrix} ) & 1 + K * ( \begin{matrix}\frac{Vb}{2} - \\ {Vc}_{1}\end{matrix} ) & 1 & 1 & 1\end{matrix} ]$$

56. The method of claim 34, wherein the inverter is a four-level, three-phase inverter, and the scale factors matrix is defined as:
$$\overline{A} = [ \begin{matrix}1 \\ 1 + K * ( Vb - ( 2 * {Vc}_{2} + {Vc}_{3} ) ) \\ 1 + K * ( Vb - ( 2 * {Vc}_{2} + {Vc}_{1} ) ) \\ 1 + K * ( \frac{Vb}{3} - {Vc}_{3} ) \\ 1 + K * ( \frac{Vb}{3} - {Vc}_{2} ) \\ 1 + K * ( \frac{Vb}{3} - {Vc}_{1} ) \\ 1 \\ 1 + K * ( Vb - ( 2 * {Vc}_{2} + {Vc}_{3} ) ) \\ 1 + K * ( Vb - ( 2 * {Vc}_{2} + {Vc}_{1} ) ) \\ 1 + K * ( \frac{Vb}{3} - {Vc}_{3} ) \\ 1 + K * ( \frac{Vb}{3} - {Vc}_{2} ) \\ 1 + K * ( \frac{Vb}{3} - {Vc}_{1} ) \\ 1 \\ 1 \\ 1 \\ 1\end{matrix} ]$$

57. The method of claim 33, further comprising:
identifying a rotating vector representing of the multi-phase voltage output from the inverter, the rotating vector being defined by a modulation index and by an electric angle in a complex plane;
at each PWM cycle, determining the sector of the complex plane in which the rotating vector is located;
determining a modified phase angle offsetting the phase of the rotating vector until bringing back the rotating vector and the sector in which it lies in a geometric condition coinciding with that of the first sector of the complex plane;
calculating the duty cycle vector (±)1 as a function of the modified phase angle and of the modulation index of the rotating vector;
detecting the voltages across the bulk capacitors of the inverter; calculating a scale factors matrix based on the detected voltages;
calculating a modified duty cycle vector as a matrix product between the duty cycle vector and the scale factors matrix;
executing a row by column product of the modified duty cycle vector by the modulation matrices;
loading the values obtained from the product between the modified duty cycle vector and the modulation matrices into a PWM modulator; and
driving the switches of the inverter as a function of the output PWM signals from the modulator.

58. The method of claim 33, wherein the modified duty cycle vector and the modulation matrix are multiplied by means of a multiply and accumulate operator.
